(19) United States
(12) Patent Application Publication
(10) Pub. No.: US 2025/0111269 A1
(43) Pub. Date: Apr. 3, 2025

(54) Incident Occurrence Prediction Using Classifiers

(71) Applicant: PageDuty, Inc., San Francisco, CA (US)

(72) Inventors: Everaldo Marques De Aguiar Junior, Seattle, WA (US); Jung Soh, Calgary (CA); Nidhi Gupta, Irvine, CA (US)

(21) Appl. No.: 18/479,862

(22) Filed: Oct. 3, 2023

(51) Int. Cl. G06N 20/00

(52) U.S. Cl. CPC G06N 20/00

(57) ABSTRACT

A current state is identified at a current time based on incidents occurring in a lookback window. Whether an incident that meets predefined criteria is likely to occur in a prediction window is predicted using a machine-learning model based on the current state. The machine-learning model is trained based on training data obtained from historical data. Each training datum of the training data includes a training lookback window and a training prediction window. Each training lookback window is used to identify incidents occurring in the each training lookback window. Each training prediction window is used to identify whether at least one incident that meets the predefined criteria occurred in the each training prediction window. In response to predicting that the incident that meets the predefined criteria is likely to occur, a notification is transmitted indicating that the incident that meets the predefined criteria is predicted to occur.

### CROSS REFERENCE TO RELATED APPLICATIONS

This application relates to U.S. patent application Ser. No. 17/697,078, filed Mar. 17, 2022, the entire disclosure of which is incorporated herein by reference.

### TECHNICAL FIELD

This disclosure relates generally to computer operations and more particularly, but not exclusively to predicting incidents to be triggered or predicting triggering services of the incidents.

### SUMMARY

A first aspect is a method that includes identifying, at a current time, a current state based on incidents occurring in a lookback window; and predicting, using a machine-learning model, whether an incident that meets predefined criteria is likely to occur in a prediction window based on the current state. The machine-learning model is trained based on training data obtained from historical data. Each training datum of the training data may include a training lookback window and a training prediction window. Each training lookback window is used to identify incidents occurring in the each training lookback window. Each training prediction window is used to identify whether at least one incident that meets the predefined criteria occurred in the each training prediction window. The method also includes, in response to predicting that the incident that meets the predefined criteria is likely to occur, performing steps that include transmitting a notification indicating that the incident that meets the predefined criteria is predicted to occur.

A second aspect is a system that includes one or more memories and one or more processors. The one or more processors are configured to execute instructions stored in the one or more memories to identify, at a current time, a current state based on incidents occurring in a lookback window; and predict, using a machine-learning model, whether an incident that meets predefined criteria is likely to occur in a prediction window based on the current state, where the machine-learning model is trained based on training data obtained from historical data. Each training datum of the training data may include a training lookback window and a training prediction window. Each training lookback window is used to identify incidents occurring in the each training lookback window. Each training prediction window is used to identify whether at least one incident that meets the predefined criteria occurred in the each training prediction window. The one or more processors are further configured to execute instructions stored in the one or more memories to, in response to predicting that the incident that meets the predefined criteria is likely to occur, perform instructions to transmit a notification indicating that the incident that meets the predefined criteria is predicted to occur.

A third aspect is one or more non-transitory computer readable media storing instructions operable to cause one or more processors to perform operations that include identifying, at a current time, a current state based on incidents occurring in a lookback window; and predicting, using a machine-learning model, whether an incident that meets predefined criteria is likely to occur in a prediction window based on the current state. The machine-learning model is trained based on training data obtained from historical data. Each training datum of the training data may include a training lookback window and a training prediction window. Each training lookback window is used to identify incidents occurring in the each training lookback window. Each training prediction window is used to identify whether at least one incident that meets the predefined criteria occurred in the each training prediction window. The operations also include, in response to predicting that the incident that meets the predefined criteria is likely to occur, performing steps that include transmitting a notification indicating that the incident that meets the predefined criteria is predicted to occur.

It will be appreciated that aspects can be implemented in any convenient form. For example, aspects may be implemented by appropriate computer programs which may be carried on appropriate carrier media which may be tangible carrier media (e.g. disks) or intangible carrier media (e.g. communications signals). Aspects may also be implemented using suitable apparatus which may take the form of programmable computers running computer programs arranged to implement the methods and/or techniques disclosed herein. Aspects can be combined such that features described in the context of one aspect may be implemented in another aspect.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 shows components of one embodiment of a computing environment for event management.

FIG. 2 shows one embodiment of a client computer.

FIG. 3 shows one embodiment of a network computer that may at least partially implement one of the various embodiments.

FIG. 4 illustrates a logical architecture of an event management bus (EMB) for predicting incidents likely to be triggered and/or triggering services.

FIG. 5A is a block diagram of example functionality of a prediction software.

FIG. 5B is a diagram illustrating a generic process 550 of training and using ML models.

FIG. 6 illustrates an example of a process for training and using an incident occurrences prediction model.

FIG. 7 illustrates an example of a process for training and using an incident types prediction model.

FIG. 8 illustrates an example of a process for training and using a services prediction model.

FIG. 9 is a block diagram of an example illustrating the operations of a template selector.

FIG. 10 illustrates examples of templates.

FIG. 11 is a flowchart of a technique for long-term incident prediction.

FIG. 12 is a flowchart of a technique for short-term incident and/or service prediction.

### DETAILED DESCRIPTION

An event management bus (EMB) is a computer system that may be arranged to monitor, manage, or compare the operations of one or more organizations. The EMB may be configured to accept various events that indicate conditions occurring in the one or more organizations. The EMB may be configured to manage several separate organizations at the same time. Briefly, an event can simply be an indication of a state of change to a component of an organization, such as hardware, software, or an IT service (or, simply, service). An event can be or describe a fact at a moment in time that may consist of a single or a group of correlated conditions that have been monitored and classified into an actionable state. As such, a monitoring tool of an organization may detect a condition in the IT environment (e.g., such as the computing devices, network devices, software applications, etc.) of the organization and transmit a corresponding event to the EMB. Depending on the level of impact (e.g., degradation of a service), if any, to one or more constituents of a managed organization, an event may trigger (e.g., may be, may be classified as, may be converted into) an incident. As such, an incident may be an unplanned disruption or degradation of service.

Non-limiting examples of events may include that a monitored operating system process is not running, that a virtual machine is restarting, that disk space on a certain device is low, that processor utilization on a certain device is higher than a threshold, that a shopping cart service of an e-commerce site is unavailable, that a digital certificate has or is expiring, that a certain web server is returning a 703 error code (indicating that web server is not ready to handle requests), that a customer relationship management (CRM) system is down (e.g., unavailable) such as because it is not responding to ping requests, and so on.

At a high level, an event may be received at an ingestion software of the EMB, accepted by the ingestion software, queued for processing, and then processed. Processing an event can include triggering (e.g., creating, generating, instantiating, etc.) a corresponding alert and a corresponding incident in the EMB, sending a notification of the incident to a responder (i.e., a person, a group of persons, etc.), and/or triggering a response (e.g., a resolution) to the incident. An alert (an alert object) may be created (instantiated) for anything that requires the performance (by a human or an automated task) of an action. Thus, the alert may embody or include the action to be performed.

An incident associated with an alert may or may not be used to notify the responder who can acknowledge (e.g., assume responsibility for resolving) and resolve the incident. An acknowledged incident is an incident that is being worked on but is not yet resolved. The user that acknowledges an incident may be said to claim ownership of the incident, which may halt any established escalation processes. As such, notifications provide a way for responders to acknowledge that they are working on an incident or that the incident has been resolved. The responder may indicate that the responder resolved the incident using an interface (e.g., a graphical user interface) of the EMB.

Incident response tends to be reactive. When an incident occurs, a workflow is typically triggered to address and mitigate the impact of the underlying condition(s) in the IT environment. This reactive approach involves predefined steps and actions aimed at containing the incident, investigating its root cause, and restoring normal operations. During an incident, IT operations are affected until the incident is resolved. As such, it would be desirable to anticipate (e.g., predict) the occurrence of incidents so that steps can be taken to prevent the predicted incidents or at least to minimize or mitigate their negative impacts.

One approach to incident prediction may involve the collection of historical data regarding a metric of interest (e.g., server response times, memory usage on a server, database response time, etc.). The historical data can be used to train a model to predict values of the metric. When actual data starts to deviate (such as by a threshold value) from predicted values obtained from the trained model, an incident is predicted to occur with respect to the metric or a monitored component related to the metric. That is, when real time data deviates from the expected norms, an incident is predicted. However, since the metric is already deviating from the norm, then a negative condition must have already occurred with respect to some monitored component. Thus, such a prediction model cannot be said to anticipate an incident that has not yet occurred and may simply be an anomaly detection model.

Implementations according to this disclosure can predict services at risk of experiencing (e.g., triggering) an incident of interest in the future (i.e., within a prediction window), can predict the type of the incident of interest (e.g., an incident template) likely to occur (e.g., to be triggered), and/or can predict whether incidents of interest are likely to be triggered. An incident-of-interest is an incident that meets certain criteria. Machine-learning (ML) models are trained to learn past incident or service occurrence patterns that are then used for predicting likely future incidents or services. The ML models can be trained to predict incidents that meet certain criteria based on the occurrence of incidents (e.g., patterns of incidents) that meet certain other criteria.

For brevity, the disclosure herein may use the term “predicting incidents.” However, “predicting incidents” should be understood to encompass not only the prediction of a specific incident with an exact title but also the prediction of an incident of a certain type or an incident that aligns with (e.g., is associated with) a specific incident template. To illustrate using but a simple example, consider two incidents: the first incident is titled “HIGH CPU USAGE OF 80% DETECTED AT 12:30:02” and the second incident is titled “HIGH CPU USAGE OF 84% DETECTED AT 06:59:02”. A textual comparison of these titles would not classify the first and the second incidents as the same incident. However, both incidents can be considered identical or similar as they align with (or may be associated with) the incident template “HIGH CPU USAGE OF <percent> DETECTED AT <time>”. This template serves as a common denominator, indicating that both incidents are of the same type, despite the differences in their specific details.

Three ML models are described herein: an incident types prediction model, a services prediction model, and an incident occurrences prediction model. The incident types prediction model and the services prediction model may also be referred to as short-term prediction models; and the incident occurrences prediction model may also be referred to as a long-term prediction model. The distinction between short-term and long-term, in this context, mainly relates to how far into the future the model predicts and how far back into the past does the model look to make its prediction. To illustrate, whereas a short-term model may look back 15 minutes and make predictions for the next 60 minutes, a long-term model may look back 6 hours and make predictions for the next 48 hours. The incident occurrences prediction model is trained to predict whether at least one incident of interest (e.g., a major incident) will occur in the future. The incident occurrences prediction model is described as not being trained to identify which particular incidents will occur in the future. However, in some implementations, the incident occurrences prediction model can be trained to identify the particular incidents that will occur.

Based on learned patterns of occurrences of incidents in historical data, the incident types prediction model learns to predict the incidents (e.g., the incidents of interest) that may be triggered in the future (in a prediction window). An incident (e.g., an incident associated with a certain template) can be predicted to occur within a prediction window given an occurrence of a pattern of incidents (e.g., incident templates) in a lookback window based on patterns of occurrences, in historical data, of incidents as compared to actual incidents occurring within a lookback window.

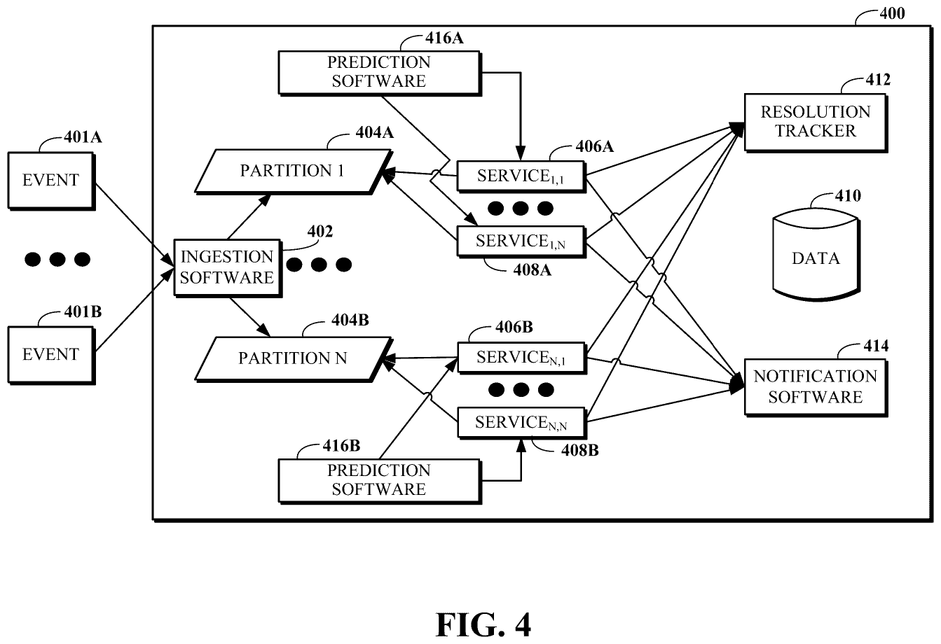

An incident may be triggered by a service. That is, an event received at the EMB with respect to the service may result in a service (described with respect to FIG. 4) of the EMB instantiating the incident. An instantiating service is referred to herein as a triggering service. Implementations according to this disclosure can also predict that a particular service may trigger an incident within a prediction window in response to determining that one or more other services triggered respective incidents within a lookback window. ML can also be used to train another model (referred to herein as a services prediction model) to predict which services may trigger incidents. Accordingly, the services prediction model may be used to output notifications such as “incidents on services S1, S2, . . . are likely in next X minutes.” In an example, each predicted service can be associated with a confidence score that reflects the reliability of the prediction.

When conditions in an IT environment are not detected until indications thereof are detected (such as described above with respect to detection of deviations from norms), significant resource utilization can result. This high usage can degrade the performance of the monitored IT environment and may even cause some operations to fail due to resource exhaustion. Frequent occurrences of such conditions can lead to degraded performance and increased resource usage. This often results in a substantial increase in investment in processing, memory, and storage resources to compensate for these conditions, which in turn can lead to increased energy expenditures required to operate these additional resources and associated emissions generated from this energy production.

Thus, by predicting incidents (and/or triggering services) before they occur, such additional resources and associated emissions can be avoided. Thus, proactively predicting incidents and services not only optimizes resource utilization but also contributes to energy efficiency and environmental sustainability.

Additionally, by predicting incidents (and their triggering services) before they occur, proactive steps can be taken to prevent the occurrence of such incidents. As such, events and alerts that would otherwise have caused services of the EMB to instantiate the incidents would not be received at, and therefore would not be processed by, the EMB. By avoiding the processing of these events and alerts, and not triggering incidents and their associated workflows, computational, storage, and network resources of the EMB can be conserved. This conservation of resources leads to a reduction in energy consumption that would otherwise be required for handling (for example, processing) such events, alerts, and incidents. As such, implementations according to this disclosure not only enhance the efficiency of the EMB but also contribute to energy conservation.

The term “organization” or “managed organization” as used herein refers to a business, a company, an association, an enterprise, a confederation, or the like.

The term “event,” as used herein, can refer to one or more outcomes, conditions, or occurrences that may be detected (e.g., observed, identified, noticed, monitored, received, etc.) by an event management bus. An event management bus (which can also be referred to as an event ingestion and processing system) may be configured to monitor various types of events depending on the needs of an industry and/or technology area. For example, information technology services (IT services) may generate events in response to one or more conditions, such as, computers going offline, memory overutilization, CPU overutilization, storage quotas being met or exceeded, applications failing or otherwise becoming unavailable, networking problems (e.g., latency, excess traffic, unexpected lack of traffic, intrusion attempts, or the like), electrical problems (e.g., power outages, voltage fluctuations, or the like), customer service requests, or the like, or combination thereof. An event (e.g., an event object) may be directly created (such as by a human) in the EMB via user interfaces of the EMB.

Events may be provided to the event management bus using one or more messages, emails, telephone calls, library function calls, application programming interface (API) calls, including, any signals provided to an event management bus indicating that an event has occurred. One or more third party and/or external systems may be configured to generate event messages that are provided to the event management bus.

The term “responder,” as used herein, can refer to a person or entity, represented or identified by persons, that may be responsible for responding to an event associated with a monitored application or service (collectively, IT services). A responder is responsible for responding to one or more notification events. For example, responders may be members of an information technology (IT) team providing support to employees of a company. Responders may be notified if an event or incident they are responsible for handling at that time is encountered. In some embodiments, a scheduler application may be arranged to associate one or more responders with times that they are responsible for handling particular events (e.g., times when they are on-call to maintain various IT services for a company). A responder that is determined to be responsible for handling a particular event may be referred to as a responsible responder. Responsible responders may be considered to be on-call and/or active during the period of time they are designated by the schedule to be available.

The term “incident” as used herein can refer to a condition or state in the managed networking environments that requires some form of resolution by a person or an automated service. Typically, incidents may be a failure or error that occurs in the operation of a managed network and/or computing environment. One or more events may be associated with one or more incidents. However, not all events are associated with incidents.

The term “incident response” as used herein can refer to the actions, resources, services, messages, notifications, alerts, events, or the like, related to resolving one or more incidents. Accordingly, services that may be impacted by a pending incident, may be added to the incident response associated with the incident. Likewise, resources responsible for supporting or maintaining the services may also be added to the incident response. Further, log entries, journal entries, notes, timelines, task lists, status information, or the like, may be part of an incident response.

The term “notification message,” “notification event,” or “notification” as used herein can refer to a communication provided by an incident management system to a message provider for delivery to one or more responsible resources or responders. A notification event may be used to inform one or more responsible resources that one or more event messages were received. For example, in at least one of the various embodiments, notification messages may be provided to the one or more responsible resources using SMS texts, MMS texts, email, Instant Messages, mobile device push notifications, HTTP requests, voice calls (telephone calls, Voice Over IP calls (VOIP), or the like), library function calls, API calls, URLs, audio alerts, haptic alerts, other signals, or the like, or combination thereof.

The term “team” or “group” as used herein refers to one or more responders that may be jointly responsible for maintaining or supporting one or more services or systems for an organization.

The following briefly describes the embodiments of the invention in order to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

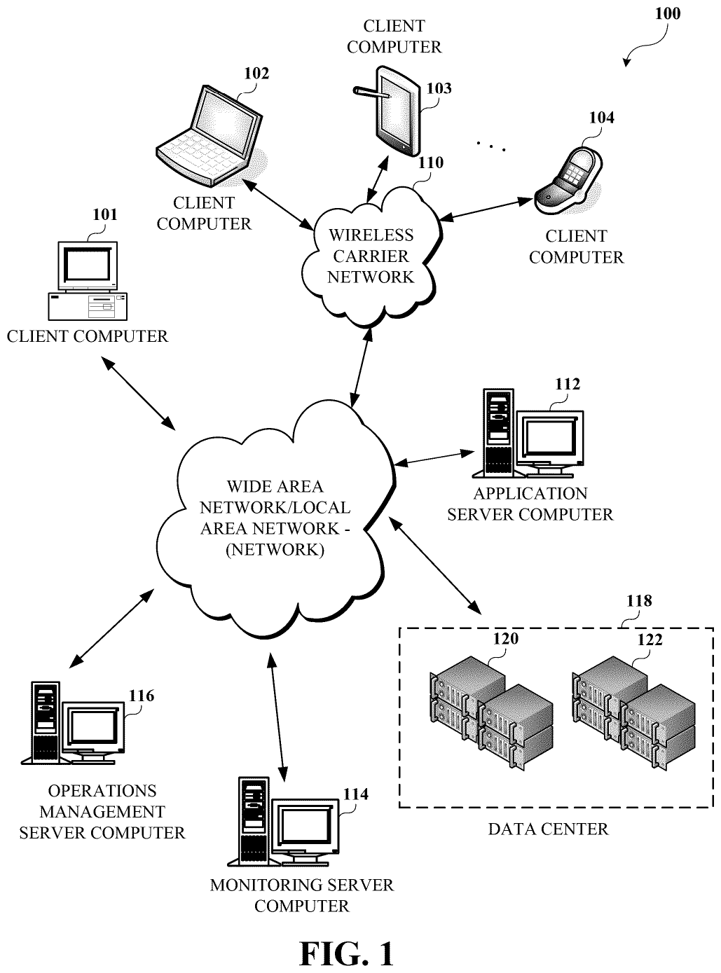

FIG. 1 shows components of one embodiment of a computing environment 100 for event management. Not all the components may be required to practice various embodiments, and variations in the arrangement and type of the components may be made. As shown, the computing environment 100 includes local area networks (LANs)/wide area networks (WANs) (i.e., a network 111), a wireless network 110, client computers 101-104, an application server computer 112, a monitoring server computer 114, and an operations management server computer 116, which may be or may implement an EMB.

Generally, the client computers 102-104 may include virtually any portable computing device capable of receiving and sending a message over a network, such as the network 111, the wireless network 110, or the like. The client computers 102-104 may also be described generally as client computers that are configured to be portable. Thus, the client computers 102-104 may include virtually any portable computing device capable of connecting to another computing device and receiving information. Such devices include portable devices such as, cellular telephones, smart phones, display pagers, radio frequency (RF) devices, infrared (IR) devices, Personal Digital Assistants (PDA's), handheld computers, laptop computers, wearable computers, tablet computers, integrated devices combining one or more of the preceding devices, or the like. Likewise, the client computers 102-104 may include Internet-of-Things (IoT) devices as well. Accordingly, the client computers 102-104 typically range widely in terms of capabilities and features. For example, a cell phone may have a numeric keypad and a few lines of monochrome Liquid Crystal Display (LCD) on which only text may be displayed. In another example, a mobile device may have a touch sensitive screen, a stylus, and several lines of color LCD in which both text and graphics may be displayed.

The client computer 101 may include virtually any computing device capable of communicating over a network to send and receive information, including messaging, performing various online actions, or the like. The set of such devices may include devices that typically connect using a wired or wireless communications medium such as personal computers, multiprocessor systems, microprocessor-based or programmable consumer electronics, network Personal Computers (PCs), or the like. In one embodiment, at least some of the client computers 102-104 may operate over wired and/or wireless network. Today, many of these devices include a capability to access and/or otherwise communicate over a network such as the network 111 and/or the wireless network 110. Moreover, the client computers 102-104 may access various computing applications, including a browser, or other web-based application.

In one embodiment, one or more of the client computers 101-104 may be configured to operate within a business or other entity to perform a variety of IT services for the business or other entity. For example, a client of the client computers 101-104 may be configured to operate as a web server, an accounting server, a production server, an inventory server, or the like. However, the client computers 101-104 are not constrained to these services and may also be employed, for example, as an end-user computing node, in other embodiments. Further, it should be recognized that more or less client computers may be included within a system such as described herein, and embodiments are therefore not constrained by the number or type of client computers employed.

A web-enabled client computer may include a browser application that is configured to receive and to send web pages, web-based messages, or the like. The browser application may be configured to receive and display graphics, text, multimedia, or the like, employing virtually any web-based language, including a wireless application protocol messages (WAP), or the like. In one embodiment, the browser application is enabled to employ Handheld Device Markup Language (HDML), Wireless Markup Language (WML), WMLScript, JavaScript, Standard Generalized Markup Language (SGML), HyperText Markup Language (HTML), extensible Markup Language (XML), HTML5, or the like, to display and send a message. In one embodiment, a user of the client computer may employ the browser application to perform various actions over a network.

The client computers 101-104 also may include at least one other client application that is configured to receive and/or send data, operations information, between another computing device. The client application may include a capability to provide requests and/or receive data relating to managing, operating, or configuring the operations management server computer 116.

The wireless network 110 can be configured to couple the client computers 102-104 with network 111. The wireless network 110 may include any of a variety of wireless sub-networks that may further overlay stand-alone ad-hoc networks, or the like, to provide an infrastructure-oriented connection for the client computers 102-104. Such sub-networks may include mesh networks, Wireless LAN (WLAN) networks, cellular networks, or the like.

The wireless network 110 may further include an autonomous system of terminals, gateways, routers, or the like connected by wireless radio links, or the like. These connectors may be configured to move freely and randomly and organize themselves arbitrarily, such that the topology of the wireless network 110 may change rapidly.

The wireless network 110 may further employ a plurality of access technologies including 2nd (2G), 3rd (3G), 4th (4G), 5th (5G) generation radio access for cellular systems, WLAN, Wireless Router (WR) mesh, or the like. Access technologies such as 2G, 3G, 4G, and future access networks may enable wide area coverage for mobile devices, such as the client computers 102-104 with various degrees of mobility. For example, the wireless network 110 may enable a radio connection through a radio network access such as Global System for Mobile communication (GSM), General Packet Radio Services (GPRS), Enhanced Data GSM Environment (EDGE), Wideband Code Division Multiple Access (WCDMA), or the like. The wireless network 110 may include virtually any wireless communication mechanism by which information may travel between the client computers 102-104 and another computing device, network, or the like.

The network 111 can be configured to couple network devices with other computing devices, including, the operations management server computer 116, the monitoring server computer 114, the application server computer 112, the client computer 101, and through the wireless network 110 to the client computers 102-104. The network 111 can be enabled to employ any form of computer readable media for communicating information from one electronic device to another. Also, the network 111 can include the internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. For example, various Internet Protocols (IP), Open Systems Interconnection (OSI) architectures, and/or other communication protocols, architectures, models, and/or standards, may also be employed within the network 111 and the wireless network 110. Furthermore, remote computers and other related electronic devices could be remotely connected to either LANs or WANs via a modem and temporary telephone link. The network 111 can include any communication method by which information may travel between computing devices.

Additionally, communication media typically embodies computer-readable instructions, data structures, program modules, or other transport mechanisms and includes any information delivery media. By way of example, communication media includes wired media such as twisted pair, coaxial cable, fiber optics, wave guides, and other wired media and wireless media such as acoustic, RF, infrared, and other wireless media. Such communication media is distinct from, however, computer-readable devices described in more detail below.

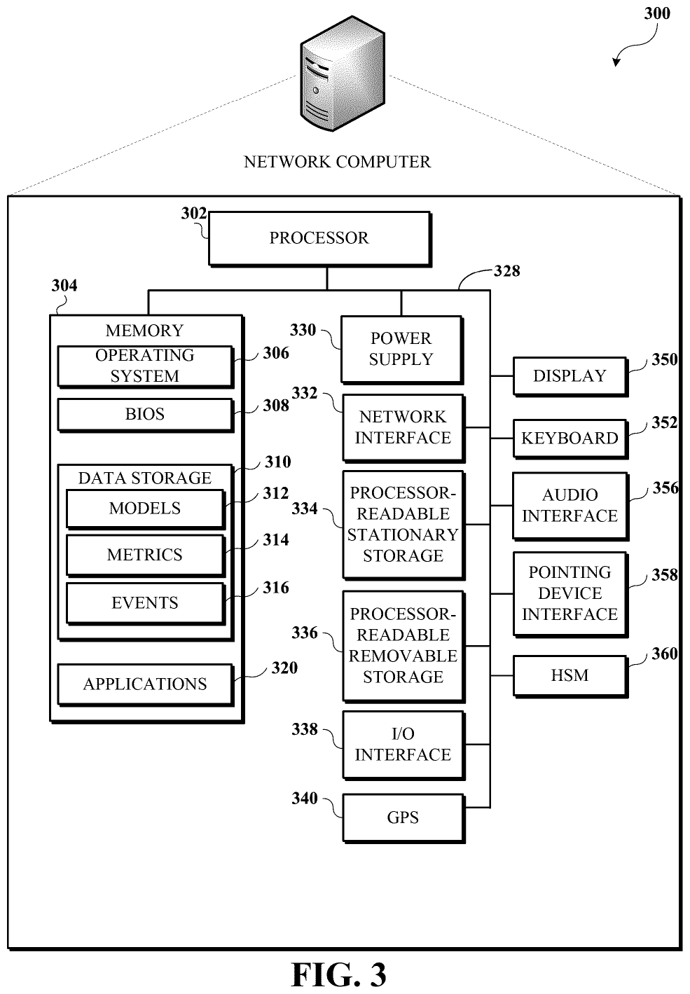

The operations management server computer 116 may include virtually any network computer usable to provide computer operations management services, such as a network computer, as described with respect to FIG. 3. In one embodiment, the operations management server computer 116 employs various techniques for managing the operations of computer operations, networking performance, customer service, customer support, resource schedules and notification policies, event management, or the like. Also, the operations management server computer 116 may be arranged to interface/integrate with one or more external systems such as telephony carriers, email systems, web services, or the like, to perform computer operations management. Further, the operations management server computer 116 may obtain various events and/or performance metrics collected by other systems, such as, the monitoring server computer 114.

The monitoring server computer 114 represents various computers that may be arranged to monitor the performance of computer operations for an entity (e.g., company or enterprise). For example, the monitoring server computer 114 may be arranged to monitor whether applications/systems are operational, network performance, trouble tickets and/or their resolution, or the like. In some embodiments, one or more of the functions of the monitoring server computer 114 may be performed by the operations management server computer 116.

Devices that may operate as the operations management server computer 116 include various network computers, including, but not limited to personal computers, desktop computers, multiprocessor systems, microprocessor-based or programmable consumer electronics, network PCs, server devices, network appliances, or the like. It should be noted that while the operations management server computer 116 is illustrated as a single network computer, the invention is not so limited. Thus, the operations management server computer 116 may represent a plurality of network computers. For example, in one embodiment, the operations management server computer 116 may be distributed over a plurality of network computers and/or implemented using cloud architecture.

Moreover, the operations management server computer 116 is not limited to a particular configuration. Thus, the operations management server computer 116 may operate using a master/slave approach over a plurality of network computers, within a cluster, a peer-to-peer architecture, and/or any of a variety of other architectures.

In some embodiments, one or more data centers, such as a data center 118, may be communicatively coupled to the wireless network 110 and/or the network 111. The data center 118 may be a portion of a private data center, public data center, public cloud environment, or private cloud environment. In some embodiments, the data center 118 may be a server room/data center that is physically under the control of an organization. The data center 118 may include one or more enclosures of network computers, such as, an enclosure 120 and an enclosure 122.

The enclosure 120 and the enclosure 122 may be enclosures (e.g., racks, cabinets, or the like) of network computers and/or blade servers in the data center 118. In some embodiments, the enclosure 120 and the enclosure 122 may be arranged to include one or more network computers arranged to operate as operations management server computers, monitoring server computers (e.g., the operations management server computer 116, the monitoring server computer 114, or the like), storage computers, or the like, or combination thereof. Further, one or more cloud instances may be operative on one or more network computers included in the enclosure 120 and the enclosure 122.

The data center 118 may also include one or more public or private cloud networks. Accordingly, the data center 118 may comprise multiple physical network computers, interconnected by one or more networks, such as, networks similar to and/or the including network 111 and/or wireless network 110. The data center 118 may enable and/or provide one or more cloud instances (not shown). The number and composition of cloud instances may vary depending on the demands of individual users, cloud network arrangement, operational loads, performance considerations, application needs, operational policy, or the like. The data center 118 may be arranged as a hybrid network that includes a combination of hardware resources, private cloud resources, public cloud resources, or the like.

As such, the operations management server computer 116 is not to be construed as being limited to a single environment, and other configurations, and architectures are also contemplated. The operations management server computer 116 may employ processes such as described below in conjunction with at least some of the figures discussed below to perform at least some of its actions.

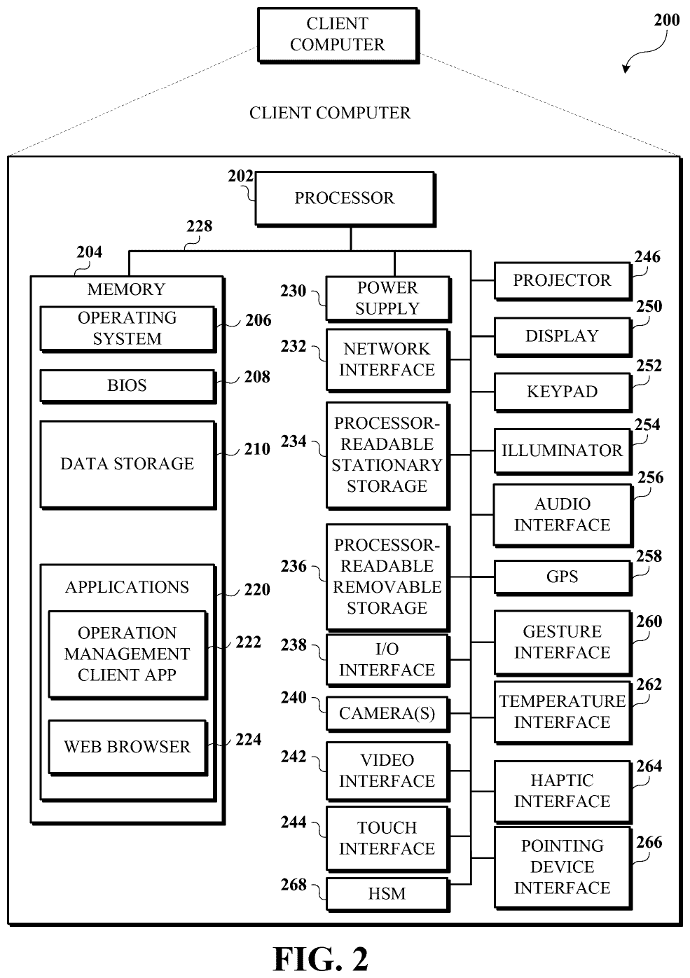

FIG. 2 shows one embodiment of a client computer 200. The client computer 200 may include more or less components than those shown in FIG. 2. The client computer 200 may represent, for example, at least one embodiment of mobile computers or client computers shown in FIG. 1.

The client computer 200 may include a processor 202 in communication with a memory 204 via a bus 228. The client computer 200 may also include a power supply 230, a network interface 232, an audio interface 256, a display 250, a keypad 252, an illuminator 254, a video interface 242, an input/output interface (i.e., an I/O interface 238), a haptic interface 264, a global positioning systems (GPS) receiver 258, an open-air gesture interface 260, a temperature interface 262, a camera 240, a projector 246, a pointing device interface 266, a processor-readable stationary storage device 234, and a non-transitory processor-readable removable storage device 236. The client computer 200 may optionally communicate with a base station (not shown), or directly with another computer. And in one embodiment, although not shown, a gyroscope may be employed within the client computer 200 to measure or maintain an orientation of the client computer 200.

The power supply 230 may provide power to the client computer 200. A rechargeable or non-rechargeable battery may be used to provide power. The power may also be provided by an external power source, such as an AC adapter or a powered docking cradle that supplements or recharges the battery.

The network interface 232 includes circuitry for coupling the client computer 200 to one or more networks, and is constructed for use with one or more communication protocols and technologies including, but not limited to, protocols and technologies that implement any portion of the OSI model for mobile communication (GSM), CDMA, time division multiple access (TDMA), UDP, TCP/IP, SMS, MMS, GPRS, WAP, UWB, WiMax, SIP/RTP, GPRS, EDGE, WCDMA, LTE, UMTS, OFDM, CDMA2000, EV-DO, HSDPA, or any of a variety of other wireless communication protocols. The network interface 232 is sometimes known as a transceiver, transceiving device, or network interface card (NIC).

The audio interface 256 may be arranged to produce and receive audio signals such as the sound of a human voice. For example, the audio interface 256 may be coupled to a speaker and microphone (not shown) to enable telecommunication with others or generate an audio acknowledgement for some action. A microphone in the audio interface 256 can also be used for input to or control of the client computer 200, e.g., using voice recognition, detecting touch based on sound, and the like.

The display 250 may be a liquid crystal display (LCD), gas plasma, electronic ink, light emitting diode (LED), Organic LED (OLED) or any other type of light reflective or light transmissive display that can be used with a computer. The display 250 may also include a touch interface 244 arranged to receive input from an object such as a stylus or a digit from a human hand, and may use resistive, capacitive, surface acoustic wave (SAW), infrared, radar, or other technologies to sense touch or gestures.

The projector 246 may be a remote handheld projector or an integrated projector that is capable of projecting an image on a remote wall or any other reflective object such as a remote screen.

The video interface 242 may be arranged to capture video images, such as a still photo, a video segment, an infrared video, or the like. For example, the video interface 242 may be coupled to a digital video camera, a web-camera, or the like. The video interface 242 may comprise a lens, an image sensor, and other electronics. Image sensors may include a complementary metal-oxide-semiconductor (CMOS) integrated circuit, charge-coupled device (CCD), or any other integrated circuit for sensing light.

The keypad 252 may comprise any input device arranged to receive input from a user. For example, the keypad 252 may include a push button numeric dial, or a keyboard. The keypad 252 may also include command buttons that are associated with selecting and sending images.

The illuminator 254 may provide a status indication or provide light. The illuminator 254 may remain active for specific periods of time or in response to event messages. For example, when the illuminator 254 is active, it may backlight the buttons on the keypad 252 and stay on while the client computer is powered. Also, the illuminator 254 may backlight these buttons in various patterns when particular actions are performed, such as dialing another client computer. The illuminator 254 may also cause light sources positioned within a transparent or translucent case of the client computer to illuminate in response to actions.

Further, the client computer 200 may also comprise a hardware security module (i.e., an HSM 268) for providing additional tamper resistant safeguards for generating, storing or using security/cryptographic information such as, keys, digital certificates, passwords, passphrases, two-factor authentication information, or the like. In some embodiments, a hardware security module may be employed to support one or more standard public key infrastructures (PKI), and may be employed to generate, manage, or store keys pairs, or the like. In some embodiments, the HSM 268 may be a stand-alone computer, in other cases, the HSM 268 may be arranged as a hardware card that may be added to a client computer.

The I/O 238 can be used for communicating with external peripheral devices or other computers such as other client computers and network computers. The peripheral devices may include an audio headset, display screen glasses, remote speaker system, remote speaker and microphone system, and the like. The I/O interface 238 can utilize one or more technologies, such as Universal Serial Bus (USB), Infrared, WiFi, WiMax, Bluetooth™, and the like.

The I/O interface 238 may also include one or more sensors for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), or the like. Sensors may be one or more hardware sensors that collect or measure data that is external to the client computer 200.

The haptic interface 264 may be arranged to provide tactile feedback to a user of the client computer. For example, the haptic interface 264 may be employed to vibrate the client computer 200 in a particular way when another user of a computer is calling. The temperature interface 262 may be used to provide a temperature measurement input or a temperature changing output to a user of the client computer 200. The open-air gesture interface 260 may sense physical gestures of a user of the client computer 200, for example, by using single or stereo video cameras, radar, a gyroscopic sensor inside a computer held or worn by the user, or the like.

The GPS receiver 258 can determine the physical coordinates of the client computer 200 on the surface of the earth, which typically outputs a location as latitude and longitude values. The GPS receiver 258 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of the client computer 200 on the surface of the earth. It is understood that under different conditions, the GPS receiver 258 can determine a physical location for the client computer 200. In at least one embodiment, however, the client computer 200 may, through other components, provide other information that may be employed to determine a physical location of the client computer, including for example, a Media Access Control (MAC) address, IP address, and the like.

Human interface components can be peripheral devices that are physically separate from the client computer 200, allowing for remote input or output to the client computer 200. For example, information routed as described here through human interface components such as the display 250 or the keypad 252 can instead be routed through the network interface 232 to appropriate human interface components located remotely. Examples of human interface peripheral components that may be remote include, but are not limited to, audio devices, pointing devices, keypads, displays, cameras, projectors, and the like. These peripheral components may communicate over a Pico Network such as Bluetooth™, Bluetooth LE, Zigbee™ and the like. One non-limiting example of a client computer with such peripheral human interface components is a wearable computer, which might include a remote pico projector along with one or more cameras that remotely communicate with a separately located client computer to sense a user's gestures toward portions of an image projected by the pico projector onto a reflected surface such as a wall or the user's hand.

A client computer may include a web browser application 226 that is configured to receive and to send web pages, web-based messages, graphics, text, multimedia, and the like. The client computer's browser application may employ virtually any programming language, including a wireless application protocol messages (WAP), and the like. In at least one embodiment, the browser application is enabled to employ Handheld Device Markup Language (HDML), Wireless Markup Language (WML), WMLScript, JavaScript, Standard Generalized Markup Language (SGML), HyperText Markup Language (HTML), eXtensible Markup Language (XML), HTML5, and the like.

The memory 204 may include RAM, ROM, or other types of memory. The memory 204 illustrates an example of computer-readable storage media (devices) for storage of information such as computer-readable instructions, data structures, program modules or other data. The memory 204 may store a BIOS 208 for controlling low-level operation of the client computer 200. The memory may also store an operating system 206 for controlling the operation of the client computer 200. It will be appreciated that this component may include a general-purpose operating system such as a version of UNIX, or LINUX™, or a specialized client computer communication operating system such as Windows Phone™, or IOS® operating system. The operating system may include, or interface with, a Java virtual machine module that enables control of hardware components or operating system operations via Java application programs.

The memory 204 may further include one or more data storage 210, which can be utilized by the client computer 200 to store, among other things, the applications 220 or other data. For example, the data storage 210 may also be employed to store information that describes various capabilities of the client computer 200. The information may then be provided to another device or computer based on any of a variety of methods, including being sent as part of a header during a communication, sent upon request, or the like. The data storage 210 may also be employed to store social networking information including address books, buddy lists, aliases, user profile information, or the like. The data storage 210 may further include program code, data, algorithms, and the like, for use by a processor, such as the processor 202 to execute and perform actions. In one embodiment, at least some of the data storage 210 might also be stored on another component of the client computer 200, including, but not limited to, the non-transitory processor-readable removable storage device 236, the processor-readable stationary storage device 234, or external to the client computer.

The applications 220 may include computer executable instructions which, when executed by the client computer 200, transmit, receive, or otherwise process instructions and data. The applications 220 may include, for example, an operations management client application 222. The operations management client application 222 may be used to exchange communications to and from the operations management server computer 116 of FIG. 1, the monitoring server computer 114 of FIG. 1, the application server computer 112 of FIG. 1, or the like. Exchanged communications may include, but are not limited to, queries, searches, messages, notification messages, events, alerts, performance metrics, log data, API calls, or the like, combination thereof.

Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, and so forth.

Additionally, in one or more embodiments (not shown in the figures), the client computer 200 may include an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. Also, in one or more embodiments (not shown in the figures), the client computer 200 may include a hardware microcontroller instead of a CPU. In at least one embodiment, the microcontroller may directly execute its own embedded logic to perform actions and access its own internal memory and its own external Input and Output Interfaces (e.g., hardware pins or wireless transceivers) to perform actions, such as System On a Chip (SOC), or the like.

FIG. 3 shows one embodiment of network computer 300 that may at least partially implement one of the various embodiments. The network computer 300 may include more or less components than those shown in FIG. 3. The network computer 300 may represent, for example, one embodiment of at least one EMB, such as the operations management server computer 116 of FIG. 1, the monitoring server computer 114 of FIG. 1, or an application server computer 112 of FIG. 1. Further, in some embodiments, the network computer 300 may represent one or more network computers included in a data center, such as, the data center 118, the enclosure 120, the enclosure 122, or the like.

As shown in the FIG. 3, the network computer 300 includes a processor 302 in communication with a memory 304 via a bus 328. The network computer 300 also includes a power supply 330, a network interface 332, an audio interface 356, a display 350, a keyboard 352, an input/output interface (i.e., an I/O interface 338), a processor-readable stationary storage device 334, and a processor-readable removable storage device 336. The power supply 330 provides power to the network computer 300.

The network interface 332 includes circuitry for coupling the network computer 300 to one or more networks, and is constructed for use with one or more communication protocols and technologies including, but not limited to, protocols and technologies that implement any portion of the Open Systems Interconnection model (OSI model), global system for mobile communication (GSM), code division multiple access (CDMA), time division multiple access (TDMA), user datagram protocol (UDP), transmission control protocol/Internet protocol (TCP/IP), Short Message Service (SMS), Multimedia Messaging Service (MMS), general packet radio service (GPRS), WAP, ultra-wide band (UWB), IEEE 802.16 Worldwide Interoperability for Microwave Access (WiMax), Session Initiation Protocol/Real-time Transport Protocol (SIP/RTP), or any of a variety of other wired and wireless communication protocols. The network interface 332 is sometimes known as a transceiver, transceiving device, or network interface card (NIC). The network computer 300 may optionally communicate with a base station (not shown), or directly with another computer.

The audio interface 356 is arranged to produce and receive audio signals such as the sound of a human voice. For example, the audio interface 356 may be coupled to a speaker and microphone (not shown) to enable telecommunication with others or generate an audio acknowledgement for some action. A microphone in the audio interface 356 can also be used for input to or control of the network computer 300, for example, using voice recognition.

The display 350 may be a liquid crystal display (LCD), gas plasma, electronic ink, light emitting diode (LED), Organic LED (OLED) or any other type of light reflective or light transmissive display that can be used with a computer. The display 350 may be a handheld projector or pico projector capable of projecting an image on a wall or other object.

The network computer 300 may also comprise the I/O interface 338 for communicating with external devices or computers not shown in FIG. 3. The I/O interface 338 can utilize one or more wired or wireless communication technologies, such as USB™, Firewire™, WiFi, WiMax, Thunderbolt™, Infrared, Bluetooth™, Zigbee™, serial port, parallel port, and the like.

Also, the I/O interface 338 may also include one or more sensors for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), or the like. Sensors may be one or more hardware sensors that collect or measure data that is external to the network computer 300. Human interface components can be physically separate from network computer 300, allowing for remote input or output to the network computer 300. For example, information routed as described here through human interface components such as the display 350 or the keyboard 352 can instead be routed through the network interface 332 to appropriate human interface components located elsewhere on the network. Human interface components include any component that allows the computer to take input from, or send output to, a human user of a computer. Accordingly, pointing devices such as mice, styluses, track balls, or the like, may communicate through a pointing device interface 358 to receive user input.

A GPS transceiver 340 can determine the physical coordinates of network computer 300 on the surface of the Earth, which typically outputs a location as latitude and longitude values. The GPS transceiver 340 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of the network computer 300 on the surface of the Earth. It is understood that under different conditions, the GPS transceiver 340 can determine a physical location for the network computer 300. In at least one embodiment, however, the network computer 300 may, through other components, provide other information that may be employed to determine a physical location of the client computer, including for example, a Media Access Control (MAC) address, IP address, and the like.

The memory 304 may include Random Access Memory (RAM), Read-Only Memory (ROM), or other types of memory. The memory 304 illustrates an example of computer-readable storage media (devices) for storage of information such as computer-readable instructions, data structures, program modules or other data. The memory 304 stores a basic input/output system (i.e., a BIOS 308) for controlling low-level operation of the network computer 300. The memory also stores an operating system 306 for controlling the operation of the network computer 300. It will be appreciated that this component may include a general-purpose operating system such as a version of UNIX, or LINUX™, or a specialized operating system such as Microsoft Corporation's Windows® operating system, or the Apple Corporation's IOS® operating system. The operating system may include, or interface with a Java virtual machine module that enables control of hardware components or operating system operations via Java application programs. Likewise, other runtime environments may be included.

The memory 304 may further include a data storage 310, which can be utilized by the network computer 300 to store, among other things, applications 320 or other data. For example, the data storage 310 may also be employed to store information that describes various capabilities of the network computer 300. The information may then be provided to another device or computer based on any of a variety of methods, including being sent as part of a header during a communication, sent upon request, or the like. The data storage 310 may also be employed to store social networking information including address books, buddy lists, aliases, user profile information, or the like. The data storage 310 may further include program code, instructions, data, algorithms, and the like, for use by a processor, such as the processor 302 to execute and perform actions such as those actions described below. In one embodiment, at least some of the data storage 310 might also be stored on another component of the network computer 300, including, but not limited to, the non-transitory media inside processor-readable removable storage device 336, the processor-readable stationary storage device 334, or any other computer-readable storage device within the network computer 300 or external to network computer 300. The data storage 310 may include, for example, models 312, operations metrics 314, events 316, or the like.

The applications 320 may include computer executable instructions which, when executed by the network computer 300, transmit, receive, or otherwise process messages (e.g., SMS, Multimedia Messaging Service (MMS), Instant Message (IM), email, or other messages), audio, video, and enable telecommunication with another user of another mobile computer. Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, and so forth. The applications 320 may be or include executable instructions, which can be loaded or copied, in whole or in part, from non-volatile memory to volatile memory to be executed by the processor 302. For example, the applications 320 can include instructions for performing some or all of the techniques of this disclosure. For example, the applications 320 can include software, tools, instructions or the like for training one or more ML models to predict occurrences of incidents, to predict incidents types, to predict services that will trigger incidents from historical incident data and to use the one or more ML models to carry out predictions. One or more of the applications may be implemented as modules or components of another application. Further, applications may be implemented as operating system extensions, modules, plugins, or the like.

Furthermore, at least some of the applications 320 may be operative in a cloud-based computing environment. These applications, and others, that include the management platform may be executing within virtual machines or virtual servers that may be managed in a cloud-based based computing environment. In this context the applications may flow from one physical network computer within the cloud-based environment to another depending on performance and scaling considerations automatically managed by the cloud computing environment. Likewise, Virtual machines or virtual servers dedicated to at least some of the applications 320 may be provisioned and de-commissioned automatically.

The applications may be arranged to employ geo-location information to select one or more localization features, such as, time zones, languages, currencies, calendar formatting, or the like. Localization features may be used in user-interfaces and well as internal processes or databases. Further, in some embodiments, localization features may include information regarding culturally significant events or customs (e.g., local holidays, political events, or the like). Geo-location information used for selecting localization information may be provided by the GPS transceiver 340. Also, in some embodiments, geolocation information may include information provided using one or more geolocation protocols over the networks, such as, the wireless network 108 or the network 111.

Also, at least some of the applications 320, may be located in virtual servers running in a cloud-based computing environment rather than being tied to one or more specific physical network computers.

Further, the network computer 300 may also comprise hardware security module (i.e., an HSM 360) for providing additional tamper resistant safeguards for generating, storing or using security/cryptographic information such as, keys, digital certificates, passwords, passphrases, two-factor authentication information, or the like. In some embodiments, a hardware security module may be employed to support one or more standard public key infrastructures (PKI), and may be employed to generate, manage, or store keys pairs, or the like. In some embodiments, the HSM 360 may be a stand-alone network computer, in other cases, the HSM 360 may be arranged as a hardware card that may be installed in a network computer.

Additionally, in one or more embodiments (not shown in the figures), the network computer 300 may include an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. Also, in one or more embodiments (not shown in the figures), the network computer may include a hardware microcontroller instead of a CPU. In at least one embodiment, the microcontroller may directly execute its own embedded logic to perform actions and access its own internal memory and its own external Input and Output Interfaces (e.g., hardware pins or wireless transceivers) to perform actions, such as System On a Chip (SOC), or the like.

FIG. 4 illustrates a logical architecture of an EMB 400 for predicting incidents likely to be triggered and/or triggering services. The EMB 400 may include various components. In this example, the EMB 400 includes an ingestion software 402, one or more partitions 404A-404B, one or more services 406A-406B and 408A-408B, a data store 410, a resolution tracker 412, a notification software 414, and prediction software 416A-416B. The data store 410 may not be included in the EMB 400.

One or more systems, such as monitoring systems, of one or more organizations may be configured to transmit events to the EMB 400 for processing. The EMB 400 may provide several services. A service may, for example, process an event and determine whether a downstream object (e.g., an incident) is to be triggered (e.g., initiated or instantiated). As mentioned above, a received event may trigger an alert, which may trigger an incident, which in turn may cause notifications to be transmitted to responders.

A received event from an organization may include an indication of one or more services that are to operate on (e.g., process, etc.) the event. The indication of the service is referred to herein as a routing key. A routing key may be unique to a managed organization. As such, two events that are received from two different managed organizations for processing by the same service would include two different routing keys. A routing key may be unique to the service that is to receive and process an event. As such, two events associated with two different routing keys and received from the same managed organization for processing may be directed to (e.g., processed by) different services.

The ingestion software 402 may be configured to receive or obtain different types of events provided by various sources, here represented by events 401A, 401B. The ingestion software 402 may be configured to accept or reject received events. In an example, events may be rejected when events are received at a rate that is higher than a configured event-acceptance rate. If the ingestion software 402 accepts an event, the ingestion software 402 may place the event in a partition (such as one of the partitions 404A, 404B) for further processing. If an event is rejected, the event is not placed in a partition for further processing. The ingestion software may notify the sender of the event of whether the event was accepted or rejected. Grouping events into partitions can be used to enable parallel processing and/or scaling of the EMB 400 so that the EMB 400 can handle (e.g., process, etc.) more and more events and/or more and more organizations (e.g., additional events from additional organizations).

The ingestion software 402 may be arranged to receive the various events and perform various actions, including, filtering, reformatting, information extraction, data normalizing, or the like, or combination thereof, to enable the events to be stored (e.g., queued, etc.) and further processed. The ingestion software 402 may be arranged to normalize incoming events into a unified common event format. Accordingly, in some embodiments, the ingestion software 402 may be arranged to employ configuration information, including, rules, maps, dictionaries, or the like, or combination thereof, to normalize the fields and values of incoming events to the common event format. The ingestion software 402 may assign (e.g., associate, etc.) an ingested timestamp with an accepted event.

An event may be stored in a partition, such as one of the partition 404A or the partition 404B. A partition can be, or can be thought of, as a queue (e.g., a first-in-first-out queue) of events. FIG. 4 is shown as including two partitions (i.e., the partitions 404A and 404B). However, the disclosure is not so limited and the EMB 400 can include one or more than two partitions.

In an example, different services of the EMB 400 may be configured to operate on events of the different partitions. In an example, the same services (e.g., identical logic) may be configured to operate on the accepted events in different partitions. To illustrate, in FIG. 4, the services 406A and 408A process the events of the partition 404A, and the services 406B and 408B process the events of partition the 404B, where the service 406A and the service 406B execute the same logic (e.g., perform the same operations) of a first service but on different physical or virtual servers; and the service 408A and the service 408B execute the same logic of a second service but on different physical or virtual servers. In an example, different types of events may be routed to different partitions. As such, each of the services 406A-406B and 408A-408B may perform different logic as appropriate for the events processed by the service.

An (e.g., each) event, may also be associated with one or more services that may be responsible for processing the events. As such, an event can be said to be addressed or targeted to the one or more services that are to process the event. As mentioned above, an event can include or can be associated with a routing key that indicates the one or more services that are to receive the event for processing.

Events may be variously formatted messages that reflect the occurrence of events or incidents that have occurred in the computing systems or infrastructures of one or more managed organizations. Such events may include facts regarding system errors, warning, failure reports, customer service requests, status messages, or the like. One or more external services, at least some of which may be monitoring services, may collect events and provide the events to the EMB 400. Events as described above may be comprised of, or transmitted to the EMB 400 via, SMS messages, HTTP requests/posts, API calls, log file entries, trouble tickets, emails, or the like. An event may include associated metadata, such as, a title (or subject), a source, a creation time stamp, a status indicator, a region, more information, fewer information, other information, or a combination thereof, that may be tracked. In an example, the event data may be received as structured data, which may be formatted using JavaScript Object Notation (JSON), XML, or some other structured format. The metadata associated with an event is not limited in any way. The metadata included in or associated with an event can be whatever the sender of the event deems required.

The data store 410 may be arranged to store performance metrics, configuration information, or the like, for the EMB 400. In an example, the data store 410 may be implemented as one or more relational database management systems, one or more object databases, one or more XML databases, one or more operating system files, one or more unstructured data databases, one or more synchronous or asynchronous event or data buses that may use stream processing, one or more other suitable non-transient storage mechanisms, or a combination thereof.

Data related to events, alerts, incidents, notifications, other types of objects, or a combination thereof may be stored in the data store 410. For example, the data store 410 can include data related to resolved and unresolved alerts. For example, the data store 410 can include data identifying whether alerts are or are not acknowledged. For example, with respect to a resolved alert, the data store 410 can include information regarding the resolving entity that resolved the alert (and/or, equivalently, the resolving entity of the event that triggered the alert), the duration that the alert was active until it was resolved, other information, or a combination thereof. The resolving entity can be a responder (e.g., a human). The resolving entity can be an integration (e.g., automated system), which can indicate that the alert was auto-resolved. That the alert is auto-resolved can mean that the EMB 400 received, such as from the integration, an event indicating that a previous event, which triggered the alert, is resolved. The integration may be a monitoring system.

The data store 410 can include historical data. The historical data include triggered incidents, data indicating the services that triggered the incidents, data indicating the services that instantiated the incidents, and metadata associated therewith. For example, respective times that the incidents were triggered (e.g., instantiated) may be associated with the incidents. The data store 410 may include a catalogue (a list) of incident templates. An incident template may be associated with an incident. That an incident template is associated with an incident can include that an identifier of an incident template is associated with the incident. The identifier of an incident template can be a hash value generated from the incident template. For example, the incident template can be a textual string and a hash value may be generated, using any known technique, from the textual string.

While not specifically shown in FIG. 4, the EMB 400 may include a component-extraction tool. The component-extraction tool may identify a service based on data associated with an event (e.g., a service identifier, a title, or a payload of the alert). Identifying a service associated with an event, as used herein, includes identifying the service based on the event. The EMB may store or access information correlating a service to at least one entity that owns the service. The entity that owns a service can be identified by the EMB by looking up the service in the information and returning the identity of the entity correlated to the service. The EMB may use the identity of the service owners to send alerts and other messages related to the events to the service owners. U.S. patent application Ser. No. 17/697,078 provides further details on identifying services, IT components, and responders associated with an event.

The incident templates stored in the data store 410 can be used by a template selector (such as a template selector of the prediction software 416A or the prediction software 416B). The template data can be used to identify (e.g., select, choose, infer, determine, etc.) a template for an incident. The data store 410 can be used to store an association between the incident and the identified template. In an example, an identifier of the identified template can be stored as metadata of the incident. As such, the data store 410 can include historical data of incidents and corresponding incident templates.

The resolution tracker 412 may be arranged to monitor the details regarding how events, alerts, incidents, other objects received, created, managed by the EMB 400, or a combination thereof are resolved. In some embodiments, this may include tracking incident and/or alert life-cycle metrics related to the events (e.g., creation time, acknowledgement time(s), resolution time, processing time,), the resources that are/were responsible for resolving the events, the resources (e.g., the responder or the automated process) that resolved alerts, and so on. The resolution tracker 412 can receive data from the different services that process events, alerts, or incidents. Receiving data from a service by the resolution tracker 412 encompasses receiving data directly from the service and/or accessing (e.g., polling for, querying for, asynchronously being notified of, etc.) data generated (e.g., set, assigned, calculated by, stored, etc.) by the service. The resolution tracker can receive (e.g., query for, read, etc.) data from the data store 410. The resolution tracker can write (e.g., update, etc.) data in the data store 410.

While FIG. 4 is shown as including one resolution tracker 412, the disclosure herein is not so limited and the EMB 400 can include more than one resolution tracker. In an example, different resolution trackers may be configured to receive data from services of one or more partitions. In an example, each partition may be associated with one resolution tracker. Other configurations or mappings between partitions, services, and resolution trackers are possible.

The notification software 414 may be arranged to generate notification messages for at least some of the accepted events. The notification messages may be transmitted to responders (e.g., responsible users, teams) or automated systems. The notification software 414 may select a messaging provider that may be used to deliver a notification message to the responsible resource. The notification software 414 may determine which resource is responsible for handling the event message and may generate one or more notification messages and determine particular message providers to use to send the notification message.

A scheduler (not shown) may determine which responder is responsible for handling an incident based on at least an on-call schedule and/or the content of the incident. The notification software 414 may generate one or more notification messages and determine a particular message provider to use to send the notification message. Accordingly, the selected message providers may transmit (e.g., communicate, etc.) the notification message to the responder. Transmitting a notification to a responder, as used herein, and unless the context indicates otherwise, encompasses transmitting the notification to a team or a group. In some embodiments, the message providers may generate an acknowledgment message that may be provided to EMB 400 indicating a delivery status of the notification message (e.g., successful or failed delivery).

The notification software 414 may determine the message provider based on a variety of considerations, such as, geography, reliability, quality-of-service, user/customer preference, type of notification message (e.g., SMS or Push Notification, or the like), cost of delivery, or the like, or combination thereof. Various performance characteristics of each message provider may be stored and/or associated with a corresponding provider performance profile. Provider performance profiles may be arranged to represent the various metrics that may be measured for a provider. Also, provider profiles may include preference values and/or weight values that may be configured rather than measured,

The EMB 400 may include various user-interfaces or configuration information (not shown) that enable organizations to establish how events should be resolved. Accordingly, an organization may define rules, conditions, priority levels, notification rules, escalation rules, routing keys, or the like, or combination thereof, that may be associated with different types of events. For example, some events (e.g., of the frequent type) may be informational rather than associated with a critical failure. Accordingly, an organization may establish different rules or other handling mechanics for the different types of events. For example, in some embodiments, critical events (e.g., rare or novel events) may require immediate (e.g., within the target lag time) notification of a response user to resolve the underlying cause of the event. In other cases, the events may simply be recorded for future analysis.

In an example, one or more of the user interfaces may be used to associate runbooks with certain types of objects. A runbook can include a set of actions that can implement or encapsulate a standard operating procedure for responding to (e.g., remediating, etc.) events of certain types. Runbooks can reduce toil. Toil can be defined as the manual or semi-manual performance of repetitive tasks. Toil can reduce the productivity of responders (e.g., operations engineers, developers, quality assurance engineers, business analysts, project managers, and the like) and prevents them from performing other value-adding work. In an example, a runbook may be associated with a template. As such, if an object matches the template, then the tasks of the runbook can be performed (e.g., executed, orchestrated, etc.) according to the order, rules, and/or workflow specified in the runbook. In another example, the runbook can be associated with a type. As such, if an object is identified as being of a certain type, then the tasks of the runbook associated with the certain type can be performed. A runbook can be assembled from predefined actions, custom actions, other types of actions, or a combination thereof.

In an example, one or more of the user interfaces may be used by responders to obtain information regarding objects and/or groups of objects. For example, a responder can use one of the user interfaces to obtain information regarding incidents assigned to or acknowledged by the responder. A user interface can be used to obtain information about an incident including the events (i.e., the group of events) associated with the incident. In an example, the responder can use the user interface to obtain information from the EMB 400 regarding the reason(s) a particular event was added to the group of events.

At least one of the services 406A-406B and 408A-408B may be configured to trigger alerts. A service can also trigger an incident from an alert, which in turn can cause notifications to be transmitted to one or more responders.

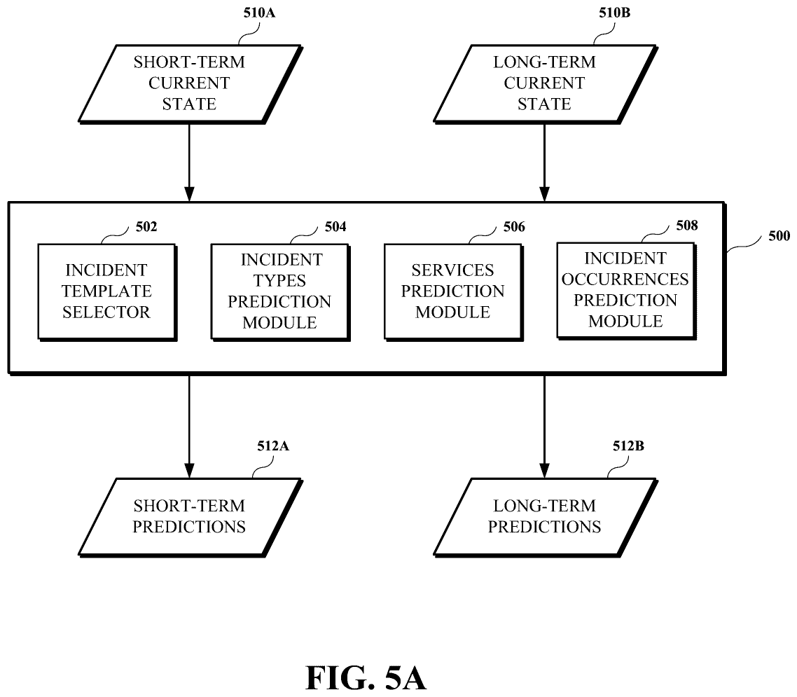

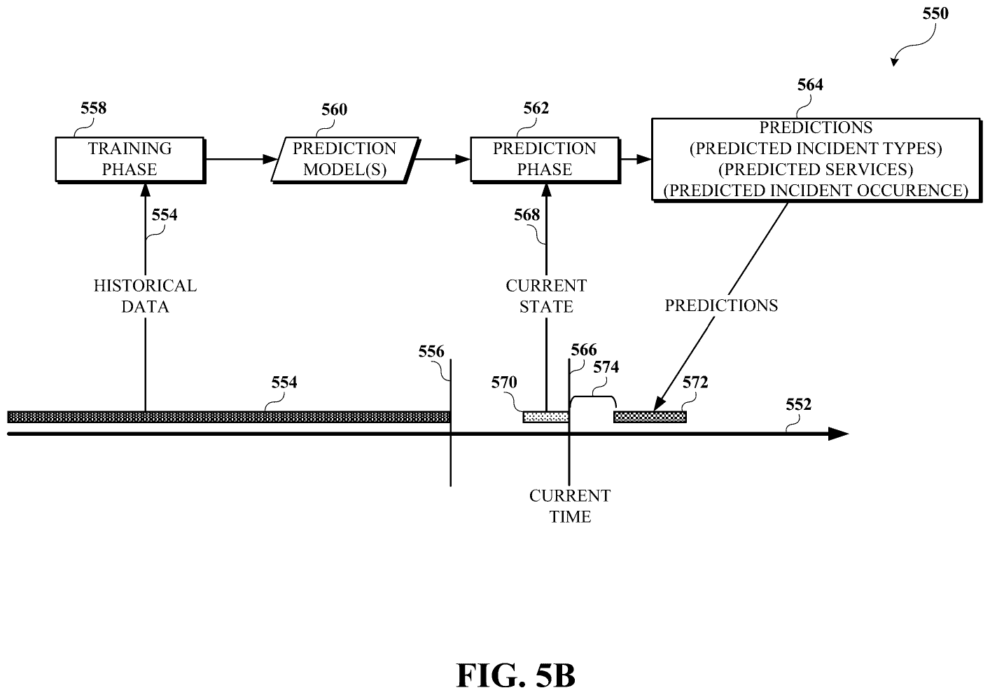

A prediction software (e.g., one or both of the prediction software 416A or 416B) can be or include one or more of an incident types prediction module, a services prediction module, and/or an incident occurrence prediction module, as further described with respect to FIG. 5A. A prediction software, such as the prediction software 416A, 416B, is associated with a respective managed organization and accesses only data (e.g., incident data) associated with that particular managed organization. As further described herein, a prediction software is trained using historical data. The historical data used are only those associated with the managed organization with which the prediction model is associated. As such, in terms of data privacy, the prediction software associated with one managed organization does not use, does not have visibility or access to, and is not trained on data from other managed organizations. More broadly, the EMB 400 itself can enforce strict data isolation amongst managed organizations.

The EMB 400 is shown as including two prediction software (i.e., the prediction software 416A-416B) where the prediction software 416A is associated with the services 406A and 408A; and the prediction software 416B is associated with the services 406B and 408B. However, other arrangements (e.g., configurations, etc.) are possible and the disclosure is not limited to the configuration shown in FIG. 4. For example, the EMB 400 may include one or more than two prediction software. For example, each of the services of the EMB 400 can be associated with its respective prediction software. For example, more than one service may be associated with a respective prediction software. For example, a respective prediction software can be available for, or associated with, one or more routing keys. Which services a prediction software is associated with can depend on whether the prediction software includes an incident types prediction module, a services prediction module, or an incident occurrences prediction module, as further described with respect to FIG. 5A.

That a prediction software is associated with a service can mean or include that the service may include the prediction software (e.g., includes the logic, instructions, tools, etc. performed by the prediction software). That a prediction software is associated with one or more services can mean that the prediction software can receive or access incident data of incidents created (e.g., triggered) by the one or more services (within a lookback window) and may perform predictions based on these incidents are described herein. That a prediction software is associated with one or more services can mean that the prediction software can receive or access incident data of incidents created (e.g., triggered) by the one or more services (within a lookback window) and may predict which services are likely to trigger incidents in the future (i.e., within a future prediction window).

The prediction software can be associated with a service in other ways. For example, alternatively or additionally, a prediction software may be configured to asynchronously receive notifications when incidents are created, such as, for example, when new incidents are stored in the data store 410, when a service instantiates (e.g., creates, writes to memory, etc.) an incident, or the like.

The prediction software can also access data relating to triggering services, which indicate which services triggered incidents and timestamps corresponding thereto. In an example, the prediction software may derive the data relating to the triggering services from incident data. For example, an incident may be associated with one or more services that triggered the incident. As such, given an incident, the prediction software can obtain the triggering service.

FIG. 5A is a block diagram of example functionality of a prediction software 500. The prediction software 500 can be one of the prediction software 416A or 416B of FIG. 4. The prediction software 500 includes tools, such as programs, subprograms, functions, routines, subroutines, operations, executable instructions, machine-learning models, and/or the like for, inter alia and as further described below, predicting whether highest-interest incidents are likely to occur within a first (i.e., a long-term) prediction window, which highest-interest incidents may be triggered in a second (i.e., a short-term) prediction window, or which services may trigger highest-interest incidents in the second prediction window.

No particular semantics are to be ascribed or attached to the terms “highest-interest” and “high-interest.” The meanings of these terms can be set for each ML model separately via respective rules (i.e., selection criteria). That is, one set of rules may be used (e.g., configured) to identify (e.g., determine, select) incidents that are highest-interest incidents; and a second set of rules may be used to identify incidents that are high-interest incidents. Two managed organizations may have different rules for what are to be considered “highest-interest” and “high-interest” incidents.

The general purpose of basing predictions on “high-interest” incidents (i.e., less than all of the incidents that occur in the lookback window) is to only base the predictions on incidents that are likely to have predictive power. There could be hundreds or thousands of incidents in the lookback window that may be transient or otherwise not have predictive significance. If such incidents were to be used in the training, then the ML model may learn erroneous patterns leading to many false positives or false negatives. Similarly, only incidents of highest-interest may be predicted so as to avoid generating too much noise and cause responders to expend resources (time or compute resources) in mitigating or attempting to prevent incidents that may be transient or have low impact.

To give but one example, highest-interest incidents may be those that tend to have cascading effects, take a significant amount of time and resources (e.g. man hours) to resolve, and cause outages or degradations to IT components. As such, highest-interest incidents may be considered to be (and are referred to herein as) major incidents. Typically, when confronted with such highest-interest incidents, responders of a managed organization may have a checklist of manual or automated tasks that they run through to identify, resolve, and/or prevent further occurrence of such events. In some situations, automated and/or manual tasks (e.g., health checks) may be regularly performed to ensure that major incidents do not occur.

As another illustration, whether an incident is determined to be a “high-interest” incident may relate to whether the incident causes notifications to be transmitted to responders regardless of the time of day. For example, if the EMB 400 is configured such that a particular interest causes notifications to be transmitted even at 3:00 AM, then the incident is a high-interest incident.

At least some of the tools of the prediction software 500 can be implemented as respective software programs that may be executed by one or more network computers, such as the network computer 300 of FIG. 3. A software program can include machine-readable instructions that may be stored in a memory such as the processor-readable stationary storage device 334 or the processor-readable removable storage device 336 of FIG. 3, and that, when executed by a processor, such as processor 302, may cause the network computer to perform the instructions of the software program.

The prediction software 500 is shown as including an incident template selector 502, an incident types prediction module 504, a services prediction module 506, and an incident occurrences prediction module 508. In some implementations, the incident template selector 502 may not be included in the prediction software 500. As such, the prediction software 500 may work in conjunction with (e.g., use) an incident template selector that is otherwise included or available in the EMB 400. In some implementations, the prediction software 500 may include less than all of the incident types prediction module 504, the services prediction module 506, and the incident occurrences prediction module 508.

The prediction software 500 may receive a short-term current state 510A and output short-term predictions 512A. The prediction software 500 may receive a long-term current state 510B and output a long-term predictions 512B. The predictions 512A, 512B are generated based on the current states 510A, 510B, respectively. Each of the current states (i.e., the short-term current state 510A and the long-term current state 510B) can be or include incidents that were triggered in (i.e., within or during) a respective lookback time window (i.e., a short-term lookback time window and a long-term lookback window, respectively). Each of the current states 510A and 510B can be or include, alternatively or additionally, data related to triggering services. However, as described above, the prediction software 500 may obtain the data related to the triggering services via incident data.

The description herein may refer to “lookback window” and “prediction window” when describing or in association with each of the incident types prediction module 504, the services prediction module 506, and the incident occurrences prediction module 508. However, it is noted that different lengths for the lookback windows and the prediction windows may be associated with each of the incident types prediction module 504, the services prediction module 506, and the incident occurrences prediction module 508. To illustrate, and without limitations, the lookback window and prediction window associated with the incident occurrences prediction module 508 may be 6 hours and at least 48 hours, respectively, whereas the lookback window and prediction window associated with the short-term prediction modules (i.e., the incident types prediction module 504 and the services prediction module 506) may be 15 minutes and one hour or less, respectively.

The short-term current state 510A can be or include data usable by the incident types prediction module 504 and/or the services prediction module 506. The current state 510A can be or include incidents triggered in a lookback window (further described with respect to FIG. 5B). Receiving the short-term current state 510A includes that the prediction software 500 accesses the current state from a data store, such as the data store 410 of FIG. 4. In the case that incident template data is not associated with the current state, the incident template selector 502 can be used to identify incident templates associated with the incidents of the current state.

With respect to the incident types prediction module 504, the short-term predictions 512A can be incidents (e.g., incident templates associated therewith) that are likely to be triggered in (e.g., within, during) the short-term prediction window. With respect to the services prediction module 506, the predictions 512A can be services, such as one or more services 406A-406B and 408A-408B of FIG. 4, that are likely to trigger incidents (i.e., incidents associated with certain templates) in (e.g., within or during) the short-term prediction window. In the case of predicting services, the short-term current state 510A can be the services that triggered incidents in the short-term lookback window. Alternatively, the prediction software 500 can identify such services based on the triggered incidents included in the short-term current state 510A.

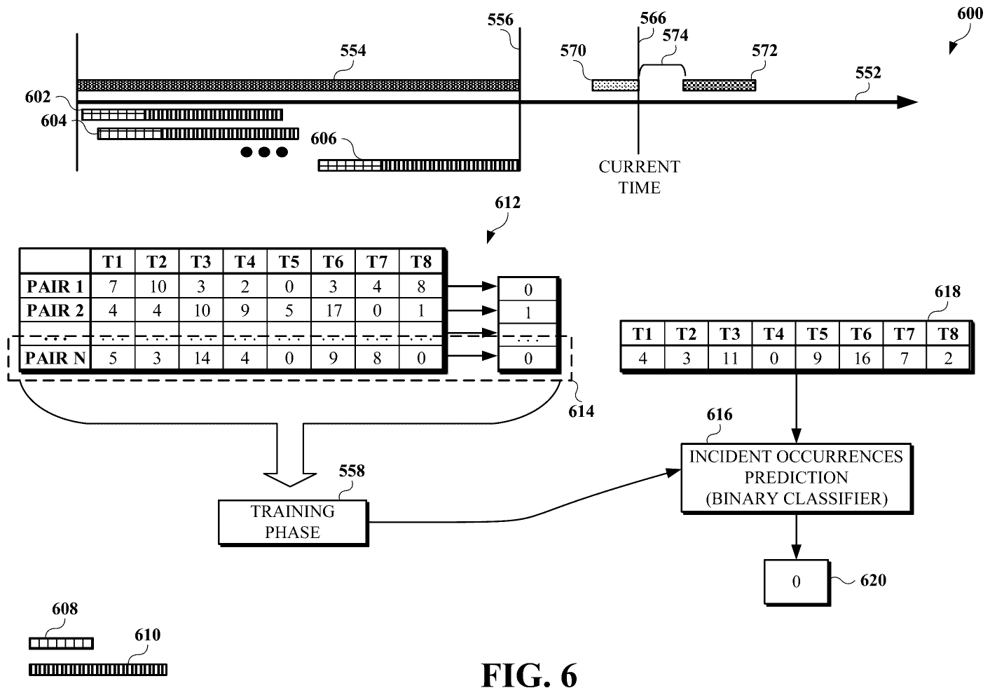

Each of the incident types prediction module 504 and the services prediction module 506 can be or include a respective ML model that is trained to identify patterns that are then used for prediction. Training and using the respective ML models are further described with respect to FIGS. 6-8.

FIG. 5B is a diagram illustrating a generic process 550 of training and using ML models described herein. The generic process 550 illustrates a timeline 552 along which incidents may be triggered by an EMB, which can be the EMB 400 of FIG. 4.

Historical data 554 up to a time point 556 are used by a training phase 558 to train a prediction model 560. The prediction model 560 can be the incident types prediction module 504, the services prediction module 506, or the incident occurrences prediction module 508 of FIG. 5A. The historical data 554 are data of one managed organization. As such, the EMB 400 of FIG. 4 can include respective ML models for different managed organizations.

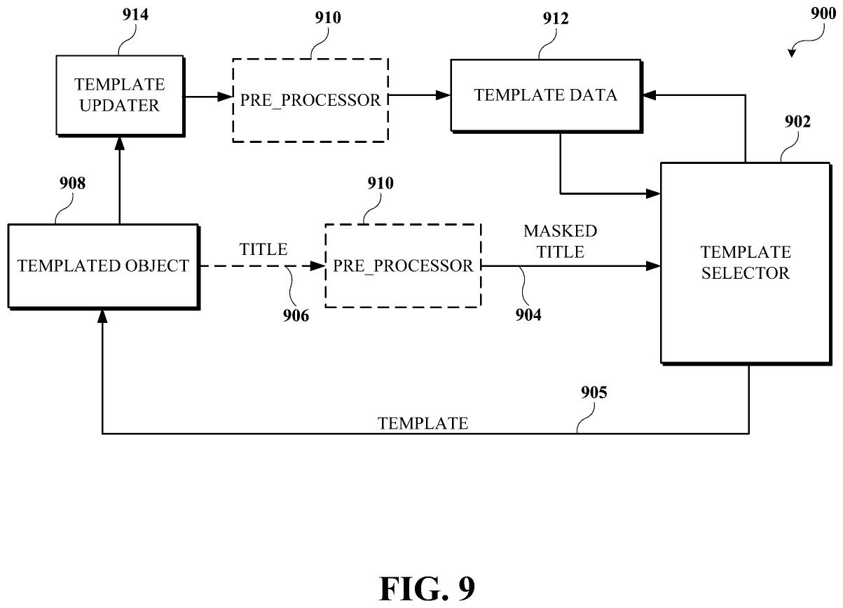

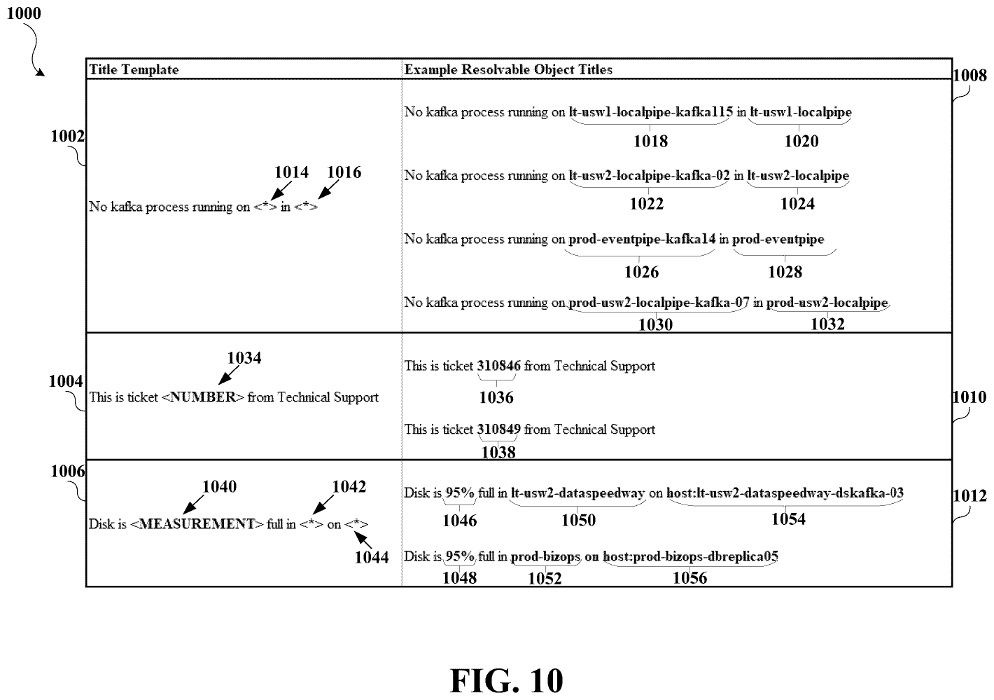

The historical data 554 can include incidents triggered up to the time point 556. The historical data 554 can include services that triggered the incidents. Alternately, and equivalently, the services that triggered the incidents can be determined (e.g., derived) from the incidents themselves. For example, the data store 410 of FIG. 4 may store association between incidents and their triggering services. The incidents can be or include incident types (e.g., incident templates). Obtaining incident templates from incidents can be as described with respect to FIGS. 9-10.

In the case of the incident occurrences prediction module 508, the historical data 554 can be data associated with one service. That is, one incident occurrences prediction module 508 may be associated with one service, is trained using data of that one service, and generate predictions for that one service. In the case of the incident types prediction module 504 and the services prediction module 506, the historical data 554 can be data associated with multiple services of a managed organization. As such, the EMB 400 can include respective incident types prediction module 504 and the services prediction module 506 for managed organizations. Said another way, one prediction software 500 may be associated with one managed organization; the managed organization may elect to have respective incident occurrences prediction modules 508 for at least some of the services associated with (e.g., created by) the managed organization; the managed organization may elect to have one incident types prediction module 504 associated therewith; and the managed organization may elect to have one services prediction module 506 associated therewith.

To reiterate, the prediction model 560 can be an incident types prediction model, a short-term services prediction model, or an incident occurrences prediction module. As mentioned above, if the prediction model 560 is an incident types prediction model, then the prediction model 560 is trained to predict future incidents (e.g., future incident templates); if the prediction model 560 is the services prediction model, then the prediction model 560 is trained to predict which services will trigger the incident templates; and if the prediction model 506 is a major incident prediction model, then the prediction model 560 is trained to predict whether at least one major incident will occur in the future. By “future” is meant within a “prediction window” (e.g., a future time window). Training the prediction model 560 is further described with respect to FIGS. 6-8.

The prediction model 560 can then be used during a prediction phase 562 (e.g., an inference phase). During the prediction phase 562, the prediction model 560 is used to generate predictions 564. The predictions 564 can be generated at a current time 566. A current state 568 is used during the prediction phase 562 as input to the prediction model 560. The current state 568 can include the incidents (or incident templates) triggered within a lookback window 570 from the current time 566. The predictions 564 are predicted to occur in a prediction window 572, which may not immediately follow the current time 566. That is, there could be a hold time 574 between the lookback window 570 and the prediction window 572. In an example, the lengths of the lookback window 570 and the prediction window 572 can be determined during the training phase 558. As already mentioned, the length (e.g., duration) of the lookback window 570 and the prediction window 572 can different for the different prediction models described herein.

The length of the hold time 574 may be pre-configured and may be changeable by an authorized user (e.g., an administrator). The hold time 574 may be set to zero. The hold time 574 may be used to provide responders with the opportunity to effectively deal with predictions. To illustrate with respect to the incident types prediction module or the services prediction module, if the predicted incidents were likely to occur very soon (e.g., in less than two minutes), then responders might not be able to act on the prediction results therewith limiting the usefulness of the predictions. The hold time 574 may be pre-configured to 5 minutes (or some other default value). As such, if the prediction window 654 was calculated to be 14 minutes in length, the actual prediction window would be between 5 and 19 minutes from a current time (e.g., the current time 566). However, as already mentioned, an authorized user can decrease or increase the hold time duration. Reducing the hold time 574 to zero (0) effectively removes the hold time altogether between the lookback window 570 and the prediction window 572. In an example, when the hold time 574 is set to zero, data from the hold time window may not be used in the training phase. In an example, when the hold time 574 is set to zero, then no predictions for the hold time window are generated.

The predictions 564 can be generated at regular intervals (e.g., every 5 seconds) to provide timely and up-to-date predictions. In an example, the regular interval can be equal in length to the lookback window 570. The predictions 564 can be one of predicted future incidents (i.e., incidents that are likely to be triggered in the prediction window 572) or predicted future services (i.e., services that are likely to trigger incidents in the prediction window 572).

While not specifically shown in FIG. 5B, and as can be appreciated, the prediction model 560 can be regularly retrained, such as every day, every week, every month, or at some other frequency.

FIG. 6 illustrates an example of a process 600 for training and using an incident occurrences prediction model 616, which can be or can be included in the incident occurrences prediction module 508 of FIG. 5A. In FIG. 5B, the same numerals are used to designate corresponding constituents in FIG. 6, and the description thereof will be appropriately omitted. Based on a current state, the incident occurrences prediction model 616 determines whether a major incident is likely to occur in a prediction window.

The incidents of the historical data 554 are divided into sliding pairs of training data, such as the pairs 602, 604, 606. The overlap between two sliding windows may be 30 minutes, 1 hour, 3 hours, 6 hours, 12 hours, 24 hours, or some other number of hours. Each of the training pairs includes a training lookback window and a training prediction window. Training lookback windows are illustrated with a pattern 608 and training prediction windows are illustrated with a pattern 610. In an example, the historical data 554 may span a duration of one month or more and each of the training lookback windows and the training prediction windows can be 6 hours and 24 hours, respectively. However, other durations are possible.

In an example, various combinations of training lookback window durations and training prediction window durations may be explored (e.g., tried), and the combination that yields the best prediction results can be selected (e.g., chosen) to be used by the trained incident occurrences prediction model 616. Within this example, the historical data 554 can be divided into two sets: training data and testing data. A specific combination can be employed to train the incident occurrences prediction model 616. Subsequently, the trained model is assessed using the testing data, which includes the actual ground truth results. The prediction outcomes are then compared to the ground truth results to determine the efficacy (e.g., accuracy) of the trained model. This process can be repeated with different combinations and the combination associated with the highest accuracy can be selected.

In each of the training lookback windows, respective counts of the different types of incidents (e.g., incident templates) that occurred are identified. Equivalently, respective counts of the different incident templates that occurred in the training lookback windows are obtained (e.g., calculated). That is, from the incidents, the corresponding incident templates can be obtained and counts of the different incident templates can be calculated. In an example, only certain types of incidents are counted (e.g., tallied).

The incidents that are counted may be those that meet certain incident selection criteria (e.g., those that meet the high-interest selection criteria). In an example, the selected incidents can be those associated with particular metadata. To illustrate using but a simple example, incidents with a field labeled “urgency” set to the value ‘high’ may be identified as high-interest incidents. In an example, a count is identified for each of the incident templates identified as being associated with the selection criteria. That is, in a first step, high-interest incidents are identified; in a second step, the associated incident templates are identified; and in a third step, the different incident templates are tallied. When instantiating an incident, the instantiating service may set metadata on the incident that may be useful in the selection process. Additionally, as an incident progresses through a resolution workflow, different data usable in the selection process may be associated (such as automated steps or responders) with the incident.

A label (e.g., a binary label) is then associated with each of the corresponding prediction windows based on whether at least one highest-interest (e.g., major) incident (or major incident template) occurred in the corresponding prediction window. Again, no particular, fixed semantics are associated with the terms “major incident,” “major incident template,” “highest-interest” or the like terms. Rules (e.g., criteria) that identify whether an incident is of highest-interest or not can be associated with the particular incident occurrences prediction module being trained. Said differently, criteria that identify whether an incident is of highest-interest or not can be associated with the particular service for which the incident occurrences prediction module is being trained. In an illustrative, non-limiting example, an incident can be identified as being a highest-interest incident if the incident meets at least a combination (e.g., all) of the criteria listed in TABLE I. However, to reiterate, the disclosure is not limited to or by the illustrative rules of TABLE I.

TABLE I
MAJOR INCIDENT IDENTIFICATION RULES

| | |
|---|---|
| 1 | The incident is labeled as being a “high” urgency incident |
| 2 | The incident is resolved after 2 minutes |
| 3 | The incident is resolved within two standard deviations of the mean |
| | time to repair (MTTR) of the incidents of the managed organization |
| 4 | The incident is resolved by a human responder or by an automated |
| | process after 5 minutes |
| 5 | The incident is acknowledged by a responder within 4 hours |
| 6 | The incident is resolved within 24 hours |
| 7 | Other incidents are grouped with the incident |

A table 612 illustrates an example of training pairs obtained from the historical data 554. A row 614 corresponds to the pair 606. The values (5, 3, 14, 4, 0, 9, 8, 0) correspond to the counts of the incident templates corresponding to the incidents that meet the selection criteria in the lookback window of the pair 606; and the value (0) corresponds to the binary label associated with the training prediction window of the pair 606. The binary label of 0 may indicate that no highest-interest incidents were identified in the training prediction window; and a binary label of 1 may indicate that at least one highest-interest incident was identified in the training prediction window.

The table 612 is used by the training phase 558 to obtain the incident occurrences prediction model 616. The incident occurrences prediction model 616 learns the patterns of incident templates in the lookback window that lead to (or are followed by) at least one highest-interest incident template in the prediction window. In an example, the incident occurrences prediction model 616 can be a fully connected neural network. In an example, the incident occurrences prediction model 616 can be a k-nearest neighbor model. The value of ‘k’ can be any positive integer (e.g., 5, 10, 20), depending on a desired predictability level. The value k can be selected in such a way as to minimize the number of false positives and false negatives. The value k can be iteratively obtained based on which value of k results in the best prediction results. The training process for a k-nearest neighbor model is omitted herein, as a person skilled in the art is already familiar with the training procedure. In other examples, the incident occurrences prediction model 616 can also be represented as a decision tree, support vector machine, or any other suitable machine learning model tailored to the task at hand.

A table 618 illustrates using the incident occurrences prediction model 616 to predict whether a major incident will occur in the prediction window 572. The table 618 includes counts of incident templates that meet the incident selection criteria in the lookback window 570. Assuming k=3, and assuming that the incident occurrences prediction model 616 includes only the three rows shown in the table 612, then the incident occurrences prediction model 616 calculates Euclidean distances between the data of the table 618 and each of the rows of table 612.

Thus, the distance between (4, 3, 11, 0, 9, 16, 7, 2) and (7, 10, 3, 2, 0, 3, 4, 8) is: sqrt((4−7)\hat{ }2+(3−10)\hat{ }2+(11−3)\hat{ }2+(0−2)\hat{ }2+(9−0)\hat{ }2+(16−3)\hat{ }2+(7−4)\hat{ }2+(2−8)\hat{ }2)=sqrt(81+49+64+4+81+169+9+36)=sqrt(513); the distance between (4, 3, 11, 0, 9, 16, 7, 2) and (4, 4, 10, 9, 5, 17, 0, 1) is: sqrt((4−4)\hat{ }2+(3−4)\hat{ }2+(11−10)\hat{ }2+(0−9)\hat{ }2+(9−5)\hat{ }2+(16−17)\hat{ }2+ (7−0)\hat{ }2+(2−1)\hat{ }2)=sqrt(0+1+1+81+16+1+49+1)=sqrt(148); and the distance between (4, 3, 11, 0, 9, 16, 7, 2) and (5, 3, 14, 4, 0, 9, 8, 0) is: sqrt((4−5)\hat{ }2+(3−3)\hat{ }2+(11−14)\hat{ }2+(0−4)\hat{ }2+(9−0)\hat{ }2+(16−9)\hat{ }2+(7−8)\hat{ }2+(2−0)\hat{ }2)=sqrt(1+9+9+16+81+49+1+4)=sqrt(270).

The incident occurrences prediction model 616 now selects the three (i.e., k=3) closest data points. In this simple example, all of the three data points are selected: the closest value sqrt(513) with label 0, the second closest value sqrt(148) with a label of 1, and the third closest value sqrt(27) with label 0. Among these three closest data points, one is associated with the label 1 and two are associated with the label 0. Since k=3, the majority class among these three is considered, which is the label 0. Therefore, the given data point (4, 3, 11, 0, 9, 16, 7, 2) is labeled with 0 using the 3-nearest neighbor algorithm. That is, the incident occurrences prediction model 616 outputs a label of 0 (i.e., a prediction output 620), indicating that given the current state shown in the table 618, a highest-interest incident is not predicted to occur in the prediction window 572. In an example, the binary label may be converted into a message (e.g., “no major incidents are predicted in the next 48 hours.”) that is displayed or transmitted to a responder.

In an example, the incident occurrences prediction model 616 may also output a confidence level in association with the label. The confidence level (or probability) can be calculated by assessing the proportion of the k-nearest neighbors that share the same label as the predicted label. Thus, in this case, since two of the k=3 nearest values have a label of 0 (indicating no highest-interest incident will occur), and one has a label of 1 (indicating that at least one highest-interest incident will occur), the confidence level would be calculated as ⅔ or approximately 66.67%. This reflects the degree of certainty in the model's prediction, suggesting a relatively high confidence in predicting the absence of a major incident in the next 48 hours in this specific scenario.

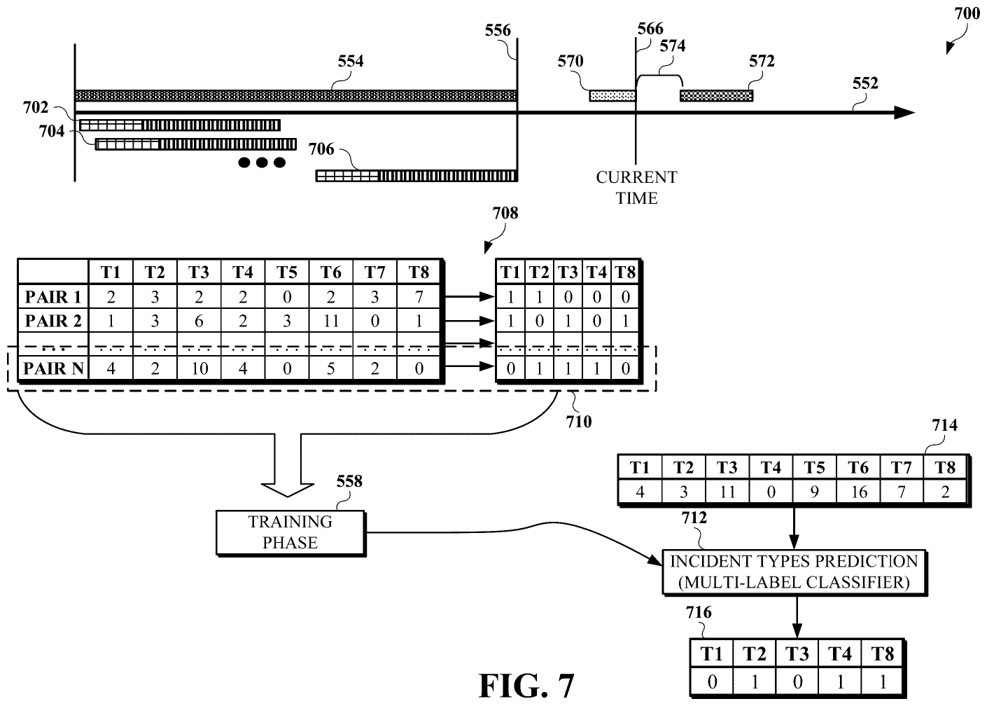

FIG. 7 illustrates an example of a process 700 for training and using an incident types prediction model 712, which can be or can be included in the incident types prediction module 504 of FIG. 5A. In FIG. 5B, the same numerals are used to designate corresponding constituents in FIG. 7, and the description thereof will be appropriately omitted. Based on a current state occurring in the lookback window 570, the incident types prediction model 712 identifies incidents (e.g., incident templates) that are likely to occur in the prediction window 572. As mentioned above, the incident types prediction model 712 can be associated with one managed organization and may transmit messages or display notifications that essentially state that “Your account is likely to have a major incident of templates T1 and T2 in the next 30 minutes,” where T1 and T2 are the templates (or template names or template descriptors) and the prediction window is 30 minutes. Thus, the incident types prediction model 712 essentially answers the question, “What types (e.g., incident templates) of highest-interest incidents will occur for the managed organization?”

Many aspects of the process 700 are similar to those described with respect to FIG. 6 and detailed descriptions therefor are omitted for brevity. However, as already mentioned whereas the historical data 554 with respect to the incident occurrences prediction model 616 is obtained from one service (for which the incident occurrences prediction model 616 is being trained), the historical data 554 with respect to the incident types prediction model 712 are obtained from multiple (e.g., all) services associated with a managed organization. Whereas a managed organization may have associated therewith several services, incident data from only a subset of the services may be used. To illustrate, some of the services may be test services and, as such, incident data generated therefrom should not be used for training or prediction.

The incidents of the historical data 554 are divided into sliding pairs of training data (i.e., training pairs), such as the pairs 702, 704, 706. Each of the training pairs includes a training lookback window and a training prediction window. In each of the training lookback windows, respective counts of the different types (i.e., templates) of incidents that occurred are identified. In an example, only certain types of incidents (e.g., of incident templates) are counted (e.g., tallied). The incidents that are counted may be those that meet certain incident selection criteria, such as described above with respect to the “high-urgency incidents” (or “high-urgency incident templates”). The selection criteria of high-urgency incidents with respect to the incident types prediction model 712 may be different from those used with respect to the incident occurrences prediction model 616.

A table 708 illustrates an example of training pairs obtained from the historical data 554. A row 710 corresponds to the pair 606. The values (4, 2, 10, 4, 0, 5, 2, 0) correspond to the counts of the incident templates corresponding to the incidents that meet the selection criteria in the lookback window of the pair 706; and the values (0, 1, 1, 1, 0) correspond to the binary labels associated with the training prediction window of the pair 706. One binary label is associated with each of the templates considered to be highest-interest incident templates (e.g., incident templates associated with incidents determined to be of highest-interest). A binary label of 0 associated with an incident template Tᵢ may indicate that no incidents associated with the incident template Tᵢ were identified in the training prediction window; and the binary label of 1 may indicate that at least one incident associated with the incident template Tᵢ were identified in the training prediction window.

The table 708 is used by the training phase 558 to obtain the incident types prediction model 712. The incident types prediction model 712 can be any suitable machine-learning model, as described above. In an example, the incident types prediction model 712 can be a multi-label k-nearest neighbor model (e.g., classifier) that is trained to output respective binary labels for incident templates determined to be of high-urgency. The value of ‘k’ can be as described above. Said another way, for each incident template identified as being a subject of prediction (e.g., identified as a highest-interest incident template), the incident types prediction model 712 may include a corresponding k-nearest neighbor model.

A table 714 illustrates using the incident types prediction model 712 to predict which highest-interest incident templates will occur in the prediction window 572. The table 708 includes counts of incident templates that meet the selection criteria in the lookback window 570. For each of the high-interest incident templates (e.g., T1, T2, T3, T4, and T8, in the illustrated scenario), Euclidean distances are calculated, as described above, and a label is output for each of the highest-interest incident templates, as illustrated in a prediction output 716. In an example, the incident types prediction model 712 may also output a confidence level in association with at least some (e.g., all) of the labels. As described above, a confidence level (or probability) can be calculated by assessing the proportion of the k-nearest neighbors that share the same label as the predicted label.

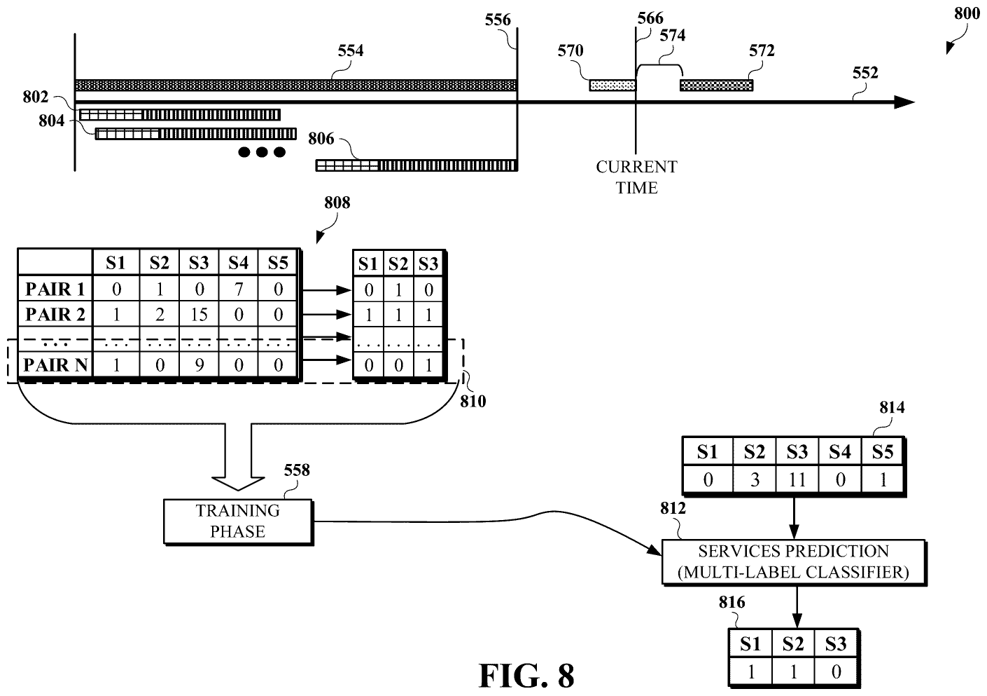

FIG. 8 illustrates an example of a process 800 for training and using a services prediction model 812, which can be or can be included in the services prediction module 506 of FIG. 5A. In FIG. 5B, the same numerals are used to designate corresponding constituents in FIG. 8, and the description thereof will be appropriately omitted. Based on a current state in the lookback window 570, the services prediction model 812 identifies services (such as one or more of the services 406A-406B and 408A-408B) that are likely to experience (e.g., trigger) major incidents (e.g., a major incident templates) in the prediction window 572. As mentioned above, the services prediction model 812 can be associated with one managed organization and may transmit messages or display notifications that essentially state, “Your account is likely to have at least one major incident on each of the services S1, S4, and S5 in the next hour,” where S1, S4, and S5 are services names or descriptors and the prediction window is 60 minutes. The services prediction model 812 essentially answers the question, “Where (i.e., in which services) will highest-interest incidents occur for the managed organization?”

Many aspects of the process 800 are similar to those described with respect to FIG. 7 and detailed descriptions therefor are omitted for brevity. The historical data 554 with respect to the services prediction model 712 are obtained from at least some (e.g., all) of the services associated with a managed organization.

The incidents of the historical data 554 are divided into sliding pairs of training data (i.e., training pairs), such as the pairs 802, 804, 806. Each of the training pairs includes a training lookback window and a training prediction window. In each of the training lookback windows, respective counts, per service, of high-interest incidents that occurred are identified. The incidents that are counted may be those that meet certain incident selection criteria, such as described above with respect to the “high-urgency incidents” (or “high-urgency incident templates”). The selection criteria of high-urgency incidents with respect to the services prediction model 812 may be different from those used with respect to the incident types prediction model 712.

A table 808 illustrates an example of training pairs obtained from the historical data 554. In the process 800, services that triggered the selected (e.g., high-interest) incidents in the lookback training windows are identified, and the incidents are tallied per service. A row 810 corresponds to the pair 806. The values (1, 0, 9, 0, 0) correspond to the counts of the incidents that meet the selection criteria in the lookback window of the pair 806 and triggered on the services (S1, S2, S3, S4, S5), respectively; and the values (0, 0, 1) correspond to the binary labels associated with the training prediction window of the pair 806. To illustrate, in the values (1, 0, 9, 0, 0), the value 9 means that 9 high-interest incidents were triggered by the service S3 in the training lookback window of the pair 806; and in the values (0, 0, 1), the value 1 indicates that the service S3 triggered at least one highest-interest incident in the training prediction window of the pair 806.

One binary label is associated with each of the services for which it is desirable to predict whether the service will trigger a major incident in the prediction window. In the illustrated example, it is desirable to identify whether the services S1, S2, and S3 will experience a major incident. The services S1, S2, and S3 may be referred to as services of interest. As such, a service of interest is a service for which the services prediction model 812 generates (i.e., is trained to generate) predictions regarding whether the service will experience (e.g., trigger) a major incident in the prediction window.

A binary label of 0 associated with a service (i.e., a service of interest) Sᵢ may indicate that no major incidents were triggered on the service Sᵢ in the training prediction window; and the binary label of 1 may indicate that at least one major incident was triggered by the service Sᵢ in the training prediction window.

The table 808 is used by the training phase 558 to obtain the services prediction model 812. The services prediction model 812 can be any suitable machine-learning model, as described above. In an example, the incident types prediction model 712 can be a multi-label k-nearest neighbor model (e.g., multi-label classifier) that is trained to output respective binary labels for services of interest. The value of ‘k’ can be as described above. While not specifically indicated above, different k values may be used for each of the incident occurrences prediction model 616 of FIG. 6, the incident types prediction model 712 of FIG. 7, and the services prediction model 812.

A table 814 illustrates using the services prediction model 812 to predict which service(s) of interest is (are) likely to trigger a major incident in the prediction window 572. The table 814 includes per-service counts of incidents that meet the selection criteria in the lookback window 570. For each of the services (e.g., S1, S2, S3, S4, and S5 in the illustrated scenario), Euclidean distances are calculated, as described above, and a label is output for each of the services of interest, as illustrated in a prediction table 816. In an example, the services prediction model 812 may also output respective confidence levels in association with at least some (e.g., all) of the labels. As described above, a confidence level (or probability) can be calculated by assessing the proportion of the k-nearest neighbors that share the same label as the predicted label.

FIG. 9 is a block diagram of an example 900 illustrating the operations of a template selector. The example 900 may be implemented in the EMB 400 of FIG. 4 or a prediction software therein. The example 900 can be implemented by the incident template selector 502 of FIG. 5. The example 900 includes a template selector 902, which can be, can be included in, or can be implemented by, one of the related-objects identifier software 418A or 418B of FIG. 4 or the prediction software 500 of FIG. 5.

As further described herein, A template is a structured pattern or format that captures both constant and variable components from templated objects. Templates serve the purpose of matching and classifying similar objects or events by analyzing their semantic meaning. By utilizing templates, it becomes possible to identify and group templated objects that share the same semantic characteristics, with all such objects mapping to the same template considered semantically similar.

The template selector 902 receives a masked title 904, which may be a masked title of a templated object 908, and outputs a corresponding template 905, if any. The templated object 908 can be any type of object with which a template can be associated. Incidents, alerts, and events are examples of templated objects. The template 905 is associated with the templated object 908. The masked title can be obtained from (e.g., generated by, etc.) a pre-processor 910, which can receive the templated object 908 or a title 906 of the templated object and outputs the masked title 904. The masked title 904 can be associated with the templated object 908. In some examples, the title 906 may not be pre-processed and the template selector 902 can identify the template 905 for the templated object 908 based on the title 906 (instead of based on the masked title 904). In an example, the pre-processor 910 can be part of, or included in, the template selector 902. As such, the template selector 902 can receive the templated object 908 (of a title therefor), pre-process the title to obtain the masked title and then obtain the template 905 based on the masked title.

Each templated object can have an associated title. The title 906 of the templated object 908 may be or may be derived from another object that may be associated with or related to the templated object 908. While the description herein may use an attribute of a templated object that may be named “title” and refers to a “masked title,” the disclosure is not so limited. Broadly, a title can be any attribute, a combination of attributes, or the like that may be associated with a templated object and from which a corresponding masked string can be obtained.

For brevity, that the template selector 902 receives the templated object 908 encompasses at least one or a combination of the following scenarios. That the template selector 902 receives the templated object 908 can mean, in an implementation, that the template selector 902 receives the templated object 908 itself. That the template selector 902 receives the templated object 908 can mean, in an implementation, that the template selector 902 receives the masked title 904 of the templated object 908. That the template selector 902 receives the templated object 908 can mean, in an implementation, that the template selector 902 receives the title 906 of the templated object 908. That the template selector 902 receives the templated object 908 can mean, in an implementation, that the template selector 902 receives a title or a masked title of an object related to the templated object 908.

The pre-processor 910 may apply any number of text processing (e.g., manipulation) rules to the title of the templated object 908 to obtain the masked title. It is noted that the title is not itself changed as a result of the text processing rules. As such, stating that a rule X is applied to the title (such as the title of the templated object), or any such similar statements, should be understood to mean that the rule X is applied to a copy of the title. The text processing rules are intended to remove sub-strings that should be ignored when generating/identifying templates, which is further described below. For effective template generation (e.g., to obtain optimal templates from titles), it may be preferable to use readable strings (e.g., strings that include words) as inputs to the template generation algorithm. However, titles may not only include readable words. Titles may also include symbols, numbers, or letters. As such, before processing a title through any template generation or template identifying algorithm, the title can be masked to remove some substrings, such as symbols or numbers, to obtain an interpretable string (e.g., a string that is semantically meaningful to a human reader).

To illustrate, and without limitations, assume that a first templated object has a first title “CRITICAL—ticket 310846 issued” and that a second templated object has a second title “CRITICAL—ticket 310849 issued.” The first and the second titles do not match without further text processing. However, as further described herein, the first and the second titles may be normalized to the same masked title “CRITICAL—ticket <NUMBER> issued.” As such, for purposes of identifying similar incidents, the first templated object and the second templated object can be considered to be related.

A set of text processing rules may be applied to a title to obtain a masked title. In some implementations, more, fewer, other rules than those described herein, or a combination thereof may be applied. The rules may be applied in a predefined order.

A first rule may be used to replace numeric substrings, such as those that represent object identifiers, with a placeholder. For example, given the title “This is ticket 310846 from Technical Support,” the first rule can provide the masked title “This is ticket <NUMBER> from Technical Support,” where the numeric substring “310846” is replaced with the placeholder “<NUMBER>.” A second rule may be used to replace substrings identified as measurements with another placeholder. For example, given the title “Disk is 95% full in lt-usw2-dataspeedway on host: lt-usw2-dataspeedway-dskafka-03,” the second rule can provide the masked title “Disk is <MEASUREMENT> full in lt-usw2-dataspeedway on host: lt-usw2-dataspeedway-dskafka-03,” where the substring “95%” is replaced with the placeholder “<MEASUREMENT>.”

The text processing rules may be implemented in any number of ways. For example, each of the rules may be implemented as a respective set of computer executable instructions (e.g., a program, etc.) that carries out the function of the rule. At least some of the rules may be implemented using pattern matching and substitution, such as using regular expression matching and substitution. Other implementations are possible.

The template selector 902 uses a template data 912, which can include templates used for matching. The template selector 902 identifies the template 905 of the template data 912 that matches the templated object 908 (or a title or a matched title, as the case may be, depending on the input to the template selector 902).

A template updater 914 can be used to update the template data 912. The template data 912 can be updated according to update criteria. In an example, templated objects received within a recent time window can be used to update the template data 912. In an example, the recent time window can be 10 seconds, 15 seconds, 1 minute, or some other recent time window. In an example, the template data 912 is updated after at least a certain number of new templated objects are created in the EMB 400 of FIG. 4. Other update criteria are possible. For example, the template data of different routing keys or of different managed organizations can be updated according to different update criteria.

In an example, the template updater 914 can be part of the template selector 902. As such, in the process of identifying templates for templated objects received within the recent time window, new templates may be added to the template data 912. Said another way, in the process of identifying a type of a templated object (based on the title or the masked title, as the case may be), if a matching template is identified, that template is used; otherwise, a new template may be added to the template data 912.

FIG. 10 illustrates examples 1000 of templates. Templates can be obtained from titles or masked titles, as the case may be. FIG. 10 illustrates three templates; namely templates 1002-1006. The templates 1002, 1004, 1006 may be derived from (i.e., at template update time) or may match (i.e., at classification time) the title groups 1008, 1010, 1012, respectively.

As mentioned above, templates include constant parts and variable parts. The constant parts of a template can be thought of as defining or describing, collectively, a distinct state, condition, operation, failure, or some other distinct semantic meaning as compared to the constant parts of other templates. The variable parts can be thought of as defining or capturing a dynamic, or variable state to which the constant parts apply.

To illustrate, the template 1002 includes, in order of appearance in the template, the constant parts “No,” “kafka,” “process,” “running,” and “in;” and includes variable parts 1014 and 1016 (represented by the pattern <*> to indicate substitution patterns). The variable part 1014 can match or can be derived from substrings 1018, 1022, 1026, and 1030 of the title group 1008; and the variable part 1016 can match or can be derived from substrings 1020, 1024, 1028, and 1032 of the title group 1008. The template 1004 does not include variable parts. However, the template 1004 includes a placeholder 1034, which is identified from or matches a mask of numeric substrings 1036 and 1038, as described above. The template 1006 includes a placeholder 1040 and variable parts 1042, 1044. The placeholder 1040 can result from or match masked portions 1046 and 1048. The variable part 1042 can match or can be derived from substrings 1050 and 1052. The variable part 1044 can match or can be derived from substrings 1054 and 1056.

In obtaining templates from titles or masked titles, as the case may be, such as by the template updater 914 of FIG. 9, it is desirable that the templates include a balance of constant and variable parts. If a template includes too many constant parts as compared to the variable parts, then the template may be too specific and would not be usable to combine similar titles together into a group or cluster for the purpose of classification. Such a template can result in false negatives (i.e., unmatched titles that should in fact be identified as similar to other titles). If a template includes too many variable parts as compared to the constant parts, then the template can practically match titles even though they are not in fact similar. Such templates can result in many false positive matches.

To illustrate, given the title “vednssoa04.atlqa1/keepalive: No keepalive sent from client for 2374 seconds (>=120),” a first algorithm may obtain a first template “vednssoa04.atlis1/keepalive: No keepalive sent from client for <*> seconds <*>,” a second algorithm may obtain a second template “<*>: <*> <*> <*> <*> client <*> <*> <*> <*>” and a third algorithm may obtain a third template “<*>: No keepalive sent from client for <*> seconds <*>.” The first template capturers (includes) very few parameters as compared to the constant parts. The second template includes too many parameters. The third template includes a balance of constant and variable parts.

The template selector 902 can be implemented in any number of ways. In an example, a log-parsing technique or algorithm can be used to obtain templates from templated objects. In an implementation, the technique or algorithm used can be an off-line technique or algorithm in which obtaining templates to match against and matching titles to templates are separate steps (e.g., separated in time) where obtaining additional templates can be a batch off-line process. In an implementation, the technique or algorithm used can be an on-line technique or algorithm in which an initial set of templates may be obtained using a batch process and new templates are obtained from titles received for matching in real-time or in near real-time.

As described with respect to FIG. 9, in the case of an off-line processor (parser) the template updater 914 may be separate from the template selector 902; and in the case of an on-line processor (parser), the template updater 914 may be part or, combined with, or works in conjunction with the template selector 902. As such, responsive to new templated data (i.e., titles or masked titles therefor) received at the template selector 902 therein of FIG. 9, the template data 912 can be recalculated (e.g., regenerated or updated) by (e.g., according to, to incorporate, etc.) any new templated data. As such, the template selector 902 not only applies existing templates of the template data 912 for matching, the template selector 902 can also update the template data 912 to include new templates, which may be influenced by the templated data (or a subset thereof).

In an example, obtaining the template may be delayed (e.g., deferred) for a short period of time until the template data 912 is updated based on most recently received templated objects according to an update criterion. The update criterion can be time based (i.e., a time-based criterion), count based (i.e., a count-based criterion), other update criterion, or a combination thereof. In example, the update criterion may be or may include updating the template data 912 at a certain time frequency (e.g., every 15 seconds or some other frequency). In example, the update criterion may be or may include updating the template data 912 after a certain number of new templated objects are received (e.g., every 100, 200, more or fewer new templated objects are received). In an example, if the count-based criterion is not met within a threshold time, then the template data 912 is updated according the new templated objects received up to the expiry of the threshold time. To illustrate, and without limitations, assume that the update criterion is set to be or equivalent to “every 75 new objects” and that a new templated object is the 56^{th} object received in the update window. A template is not obtained for this templated object until after the 75^{th} templated object is received and the template data 912 is updated using the 75 new objects.

Examples of techniques or algorithms that may be used include, but are not limited to using well known techniques such as regular expression parsing, Streaming structured Parser for Event Logs using Longest common subsequence (SPELL), Simple Logfile Clustering Tool (SLECT), Iterative Partitioning Log Mining (IPLoM), Log File Abstraction (LFA), Depth tRee based onlIne log parsiNg (DRAIN), or other similar techniques or algorithms. At least some of these algorithms or techniques are machine learning techniques that use unsupervised learning to learn (e.g., incorporate) new templates in their respective models based on newly received data. In an example, DRAIN may be used. A detailed description of DRAIN or any of the other algorithms is not necessary as a person skilled in the art is, or can easily become, familiar with log parsing techniques, including DRAIN, which is a machine learning model that uses unsupervised learning.

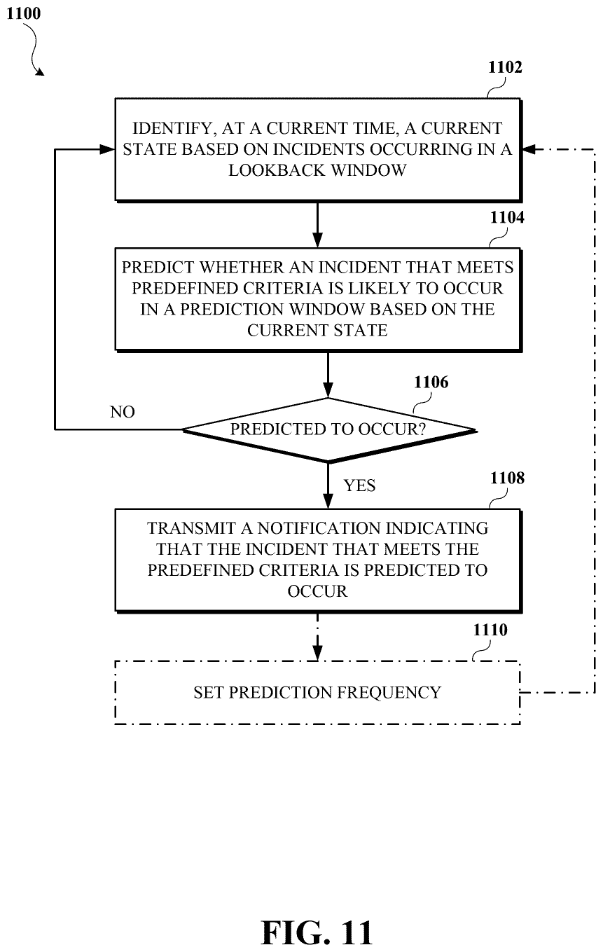

FIG. 11 is a flowchart of a technique 1100 for long-term incident prediction. The technique 1100 can be implemented, for example, as a software program that may be executed by a computing device such as the network computer 300 of FIG. 3. The software program can include machine-readable instructions that may be stored in one or more memories or one or more network computers, such as one or more of the memory 304, the processor-readable stationary storage device 334, or the processor-readable removable storage device 336 of FIG. 3, and that, when executed by a processor, such as the processor 302 of FIG. 3, may cause the computing device to perform the technique 1100. The technique 1100 can be implemented using specialized hardware or firmware. Multiple processors of one or more network computers, memories of one or more network computers, or both, may be used. The technique 1100 can be implemented, at least in part by a prediction software, such as the prediction software 500 of FIG. 5A. More specifically, the technique 1100 can be executed by the incident occurrences prediction module 508 of the prediction software.

At 1102, a current state is identified based on incidents occurring in a lookback window. The lookback window can be the lookback window 570 of FIG. 5B. Incidents occurring in the lookback window means incidents triggered during the lookback window. In an example, the current state can include the incidents themselves and respective counts of similar incidents. In an example, the current state can include incident templates. As such, incident templates associated with the incidents occurring in the lookback window can be identified based on associations between incidents and incident templates. In an example, the incident templates can be obtained (e.g., identified, derived, etc.) as described with respect to FIG. 9 and the incident template selector 502 of FIG. 5. Respective counts of distinct incident templates in the incident templates are determined. As such, the current state can include the distinct incident templates and the respective counts of the distinct incident templates.

The incidents used to identify the current state can be a subset of all the incidents that occurred in the lookback window. The selected incidents can be based on incident selection criteria, such as described above with respect to high-interest incidents. In an example, the prediction window can correspond to a future duration of at least 48 from the current time. In an example, the lookback window can correspond to a duration of six hours prior to the current time.

At 1104, whether an incident that meets predefined criteria is likely to occur in a prediction window is predicted based on the current state. As described above, predicting whether an incident that meets predefined criteria is likely to occur can mean or include predicting that an incident template associated with the incident that meets the predefined criteria is likely to occur in the prediction window.

The predefined criteria can be as described with respect to highest-interest incidents. The prediction can be made by an ML model that can be the incident occurrences prediction model 616 described with respect to FIG. 6. The ML model can be or can be included in the incident occurrences prediction module 508 of FIG. 5A. As such, the ML model can be a k-nearest neighbors model and the prediction can be a binary value indicating whether the incident that meets the predefined criteria is likely to occur in the prediction window. In an example, a probability of whether the incident that meets the predefined criteria is likely to occur can also be obtained from the ML model.

As described above, the ML model can be trained based on training data obtained from historical data. Each training datum of the training data can include a training lookback window and a training prediction window. Each training lookback window can be used to identify incidents occurring in that training lookback window. Each training prediction window can be used to identify whether at least one incident that meets the predefined criteria occurred in that training prediction window.

At 1106, the technique 1100 determines whether an incident that meets the predefined criteria is predicted to occur. If so (i.e., in response to predicting that the incident that meets the predefined criteria is likely to occur), the technique 1100 proceeds to 1108; otherwise, the technique 1100 proceeds back to 1102 to generate another prediction. The technique 1100 may be configured to execute at a first (e.g., initial) frequency (e.g., every six hours).

At 1108, a notification indicating that the incident that meets the predefined criteria is predicted to occur may be transmitted to one or more responders. In an example, the notification may include a likelihood (e.g., a probability) score associated with the prediction. In an example, the k-nearest patterns that led to the prediction may also be obtained from the ML model and included in the notification. In an example, a predefined set of diagnostic and preventative (manual or automated) tasks may be executed to mitigate or to prevent outages that may be caused if the incident were to materialize.

At 1110, and in an example, the technique 1100 may update the prediction frequency to a second frequency that is higher than the first frequency. Setting the higher frequency results in predictions being generated more frequently. This way, as more and more predictions (and probability values associated therewith) are generated, responders can better monitor whether such incidents will in fact materialize and can see a trend line of the probability values. The responders can thus monitor the effectiveness of any diagnostic and preventative tasks. Additionally, if the trendline is not decreasing, then the technique 1100 may kick off (e.g., execute) configured escalation procedures.

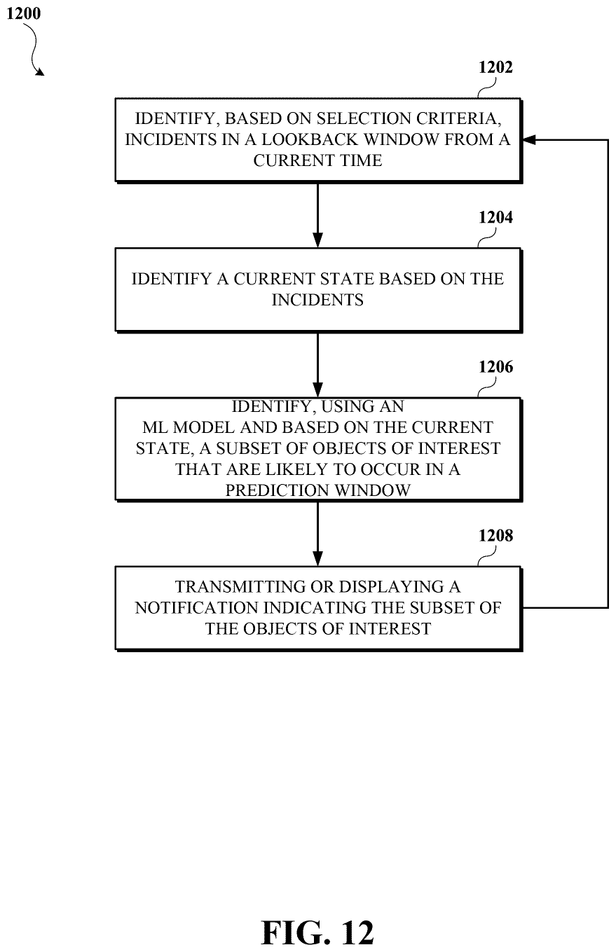

FIG. 12 is a flowchart of a technique 1200 for short-term incident and/or service prediction. The technique 1200 can be implemented, for example, as a software program that may be executed by a computing device such as the network computer 300 of FIG. 3. The software program can include machine-readable instructions that may be stored one or more memories or one or more network computers, such as one or more of the memory 304, the processor-readable stationary storage device 334, or the processor-readable removable storage device 336 of FIG. 3, and that, when executed by a processor, such as the processor 302 of FIG. 3, may cause the computing device to perform the technique 1200. The technique 1200 can be implemented using specialized hardware or firmware. Multiple processors of one or more network computers, memories of one or more network computers, or both, may be used. The technique 1200 can be implemented at least in part by a prediction software, such as the prediction software 500 of FIG. 5A.

At 1202, incidents are identified (e.g., selected, determined, etc.) in a lookback window from a current time based on selection criteria. The selection criteria can be as described above with respect to high-interest incidents. At 1204, a current state is identified based on the incidents. At 1206, an ML model is used to identify a subset of objects of interest that are likely to occur in a prediction window. The ML model can be a k-nearest neighbors model that is trained based on training data obtained from historical data. Each training datum of the training data includes a training lookback window and a training prediction window. Each training lookback window can be used to identify incidents occurring in that training lookback window. Each training prediction window is used to identify which of the objects of interest occurred in that training prediction window. In an example, the lookback window can be within a range of 15 to 30 minutes prior to the current time. In an example, the prediction window can be within 120 minutes from (e.g., after) the current time.

In an example, the objects of interest can be incident templates that the ML model is trained to predict. As such, the ML model can be the incident types prediction model 712 of FIG. 7, or can be or can be included in the incident types prediction module 504 of FIG. 5A. As such, identifying the current state based on the incidents can include identifying incident templates associated with the incidents and determining respective counts of distinct incident templates in the incident templates, such as described with respect to FIG. 7. As such, the current state can include the distinct incident templates and the respective counts of the distinct incident templates. As described above, incidents that are semantically similar are associated with the same incident template.

In another example, the objects of interest can be services that trigger incidents. As such, the ML model can be the services prediction model 812 of FIG. 8, or can be or can be included in the services prediction module 506 of FIG. 5A. As such, identifying the current state based on the incidents can include identifying services that triggered the incidents and determining respective counts of distinct services in the services, as described with respect to FIG. 8. As such, the current state can include the distinct services and the respective counts of the distinct services.

In an example, respective binary values can be received from (e.g., output by) the ML model for the objects of interest. A first binary value (e.g., 1) can be associated with each of the objects of the subset of the objects of interest and a second binary value (e.g., 0) can be associated with the remaining objects of the objects of interest. That is, those objects of interest that are predicted may receive predictions of 1 and those not predicted may receive a prediction of 0. In an example, respective likelihood values (e.g., probabilities) may be output by the ML model in association with the first binary values. The ML model can be periodically retrained based on new training data. In an example, the respective k-nearest patterns that led to the predictions may also be obtained from (e.g., output by) the ML model and included in the notification.

At 1206, a notification of the subset of the objects of interest can be transmitted or displayed to responders. From 1206, the technique 1200 proceeds back to 1202. The technique 1200 may be configured to execute (e.g., to generate predictions) on a period basis (e.g., according to a prediction frequency).

In an example, the technique 1200 can include, as described with respect to FIG. 4, receiving, during the lookback window, events related to information technology components. Respective services of a plurality of services are identified for processing the events. Incidents can be generated by the respective services from the of the events based on criteria of the events.

For simplicity of explanation, the processes and techniques, such as the techniques 1100, and 1200 of FIGS. 11 and 12, respectively, are each depicted and described herein as respective series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments may be readily combined, without departing from the scope or spirit of this disclosure.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

For example embodiments, the following terms are also used herein according to the corresponding meaning, unless the context clearly dictates otherwise.

As used herein the term, “software” refers to logic embodied in hardware or software instructions, which can be written in a programming language, such as C, C++, Objective-C, COBOL, Java™, PHP, Perl, JavaScript, Ruby, VBScript, Microsoft .NET™ languages such as C#, and/or the like. A software may be compiled into executable programs or written in interpreted programming languages. Software may be callable from other software or from themselves. Any software described herein refers to one or more logical modules that can be merged with other software or applications, or can be divided into sub-software or tools. The software can be stored in non-transitory computer-readable medium or computer storage devices and be stored on and executed by one or more general purpose computers, thus creating a special purpose computer configured to provide the software.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media, and can include volatile memory or non-volatile memory that can change over time. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method, comprising:
identifying, at a current time, a current state based on incidents occurring in a lookback window;
predicting, using a machine-learning model, whether an incident that meets predefined criteria is likely to occur in a prediction window based on the current state,
wherein the machine-learning model is trained based on training data obtained from historical data,
wherein each training datum of the training data comprises a training lookback window and a training prediction window,
wherein each training lookback window is used to identify incidents occurring in the each training lookback window, and
wherein each training prediction window is used to identify whether at least one incident that meets the predefined criteria occurred in the each training prediction window; and
in response to predicting that the incident that meets the predefined criteria is likely to occur, performing steps comprising:
transmitting a notification indicating that the incident that meets the predefined criteria is predicted to occur.

2. The method of claim 1, wherein the machine-learning model is a k-nearest neighbors model.

3. The method of claim 1, wherein predicting, using the machine-learning model, whether the incident that meets the predefined criteria is likely to occur in the prediction window based on the current state comprises:
obtaining from the machine-learning model a probability of whether the incident that meets the predefined criteria is likely to occur.

4. The method of claim 1, wherein predicting, using the machine-learning model, whether the incident that meets the predefined criteria is likely to occur in the prediction window based on the current state comprises:
obtaining a binary value indicating whether the incident that meets the predefined criteria is likely to occur in the prediction window.

5. The method of claim 1, wherein the prediction window corresponds to a future duration of at least forty eight hours from the current time.

6. The method of claim 1, wherein the lookback window corresponds to a duration of six hours prior to the current time.

7. The method of claim 1, further comprising:
setting a first frequency for generating predictions using the machine-learning model,
wherein the steps performed in response to predicting that the incident that meets the predefined criteria is likely to occur further comprise:
setting a second frequency that is higher than the first frequency for generating the predictions using the machine-learning model.

8. The method of claim 1, wherein the incidents occurring in the lookback window constitute a subset of all incidents occurring in the lookback window selected based on incident selection criteria.

9. The method of claim 1, wherein identifying, at the current time, the current state based on the incidents occurring in the lookback window comprises:
identifying incident templates associated with the incidents occurring in the lookback window; and
determining respective counts of distinct incident templates in the incident templates, wherein the current state comprises the distinct incident templates and the respective counts of the distinct incident templates.

10. The method of claim 1, wherein predicting, using the machine-learning model, whether the incident that meets the predefined criteria is likely to occur in the prediction window based on the current state comprises:
predicting that an incident template associated with the incident that meets the predefined criteria is likely to occur in the prediction window.

11. A system, comprising:
one or more memories; and
one or more processors, the one or more processors configured to execute instructions stored in the one or more memories to:
identify, at a current time, a current state based on incidents occurring in a lookback window;
predict, using a machine-learning model, whether an incident that meets predefined criteria is likely to occur in a prediction window based on the current state,
wherein the machine-learning model is trained based on training data obtained from historical data,
wherein each training datum of the training data comprises a training lookback window and a training prediction window,
wherein each training lookback window is used to identify incidents occurring in the each training lookback window, and
wherein each training prediction window is used to identify whether at least one incident that meets the predefined criteria occurred in the each training prediction window; and
in response to predicting that the incident that meets the predefined criteria is likely to occur, perform instructions to:
transmit a notification indicating that the incident that meets the predefined criteria is predicted to occur.

12. The system of claim 11, wherein the machine-learning model is a k-nearest neighbors model.

13. The system of claim 11, wherein to predict, using the machine-learning model, whether the incident that meets the predefined criteria is likely to occur in the prediction window based on the current state comprises to:
obtain from the machine-learning model a probability of whether the incident that meets the predefined criteria is likely to occur.

14. The system of claim 11, wherein to predict, using the machine-learning model, whether the incident that meets the predefined criteria is likely to occur in the prediction window based on the current state comprises to:
obtain a binary value indicating whether the incident that meets the predefined criteria is likely to occur in the prediction window.

15. The system of claim 11, wherein the prediction window corresponds to a future duration of at least forty eight hours from the current time.

16. The system of claim 11, wherein the lookback window corresponds to a duration of six hours prior to the current time.

17. One or more non-transitory computer readable media storing instructions operable to cause one or more processors to perform operations comprising:
identifying, at a current time, a current state based on incidents occurring in a lookback window;
predicting, using a machine-learning model, whether an incident that meets predefined criteria is likely to occur in a prediction window based on the current state,
wherein the machine-learning model is trained based on training data obtained from historical data,
wherein each training datum of the training data comprises a training lookback window and a training prediction window,
wherein each training lookback window is used to identify incidents occurring in the each training lookback window, and
wherein each training prediction window is used to identify whether at least one incident that meets the predefined criteria occurred in the each training prediction window; and
in response to predicting that the incident that meets the predefined criteria is likely to occur, performing steps comprising:
transmitting a notification indicating that the incident that meets the predefined criteria is predicted to occur.

18. The one or more non-transitory computer readable media of claim 17, wherein the operations further comprise:
setting a first frequency for generating predictions using the machine-learning model,
wherein the steps performed in response to predicting that the incident that meets the predefined criteria is likely to occur further comprise:
setting a second frequency that is higher than the first frequency for generating the predictions using the machine-learning model.

19. The one or more non-transitory computer readable media of claim 17, wherein identifying, at the current time, the current state based on the incidents occurring in the lookback window comprises:
identifying incident templates associated with the incidents occurring in the lookback window; and
determining respective counts of distinct incident templates in the incident templates, wherein the current state comprises the distinct incident templates and the respective counts of the distinct incident templates.

20. The one or more non-transitory computer readable media of claim 17, wherein predicting, using the machine-learning model, whether the incident that meets the predefined criteria is likely to occur in the prediction window based on the current state comprises:
predicting that an incident template associated with the incident that meets the predefined criteria is likely to occur in the prediction window.
